(19) United States
(12) Patent Application Publication
(10) Pub. No.: US 2005/0081463 A1
(43) Pub. Date: Apr. 21, 2005

(54) Retractable screen system providing a positioning force for a movable sash

(76) Inventors: Richard Allen, West Lakeland Township, MN (US); Todd N. Stratmoen, Mahtomedi, MN (US); Michael Gonnerman, Lakeville, MN (US); Rashid Darayus Bharucha, Roseville, MN (US); Gabriel Gromotka, Pella, IA (US); Keith Kibbel, Forest Lake, MN (US); Steven Edward Cory, Mason City, IA (US)

Correspondence Address: Karl G. Schwappach;Faegre & Benson LLP, 2200 Wells Fargo Center, 90 South Seventh Street, Minneapolis, MN, 55402-3901, US

(21) Appl. No.: 10/687,863

(22) Filed: Oct. 17, 2003

(51) Int. Cl. E06B 1/04

(52) U.S. Cl. 52/204.1

(57) ABSTRACT

A door with a moveable window sash and a method of operating the same. The door includes vertical jambs with vertical channels. A window sash is movable in the vertical channels. A retractable screen assembly is attached to the door. The retractable screen assembly includes a roller, a flexible screen attached at a first end to the roller and at a second end to the movable window sash, and a biasing mechanism adapted to apply a continuous torque to the roller. The torque generates a positioning force on the window sash equal to at least 50% of the force of gravity acting on a window sash, such that the window sash can be positioned at an infinite number of locations along the vertical channels.

### FIELD OF THE INVENTION

The present invention relates to a retractable screen system adapted to provide a positioning force for moveable sash in a fenestration product. The retractable screen extends and retracts across the opening created by movement of the sash. An infinite positioning device can optionally be used in combination with the retractable screen system.

### BACKGROUND OF THE INVENTION

A basic problem with traditional hung windows designed to be raised and lowered by sliding within vertical jamb channels is how to retain the sash in a particular location. To overcome this problem, many different types of sash positioning devices have been developed to both retain the sash in a particular position and permit the sash to be moved easily when desired. For example, U.S. Pat. No. 3,080,620 discloses a storm window that uses spring loaded latches that engage with notches located at fixed intervals along the vertical window jamb. The storm windows can only be positioned at the locations where the manufacturer locates the notches.

Pulley arrangements with counterweights or springs that bias the sash upward have also been used, such as disclosed in commonly assigned, published U.S. patent application No. 2002/0121618 (application Ser. No. 10/026,669). Numerous techniques have also been used in conjunction with springs to hold the sash stationary in any given vertical position when the operator is released, yet permit the operator to raise or to lower it with minimal effort. Example of such devices are disclosed in U.S. Pat. Nos. 3,080,620, 3,788,006, 4,015,367, 4,570,382, 4,571,887, 4,763,447, 4,779,380, and 5,033,235.

Various frictional devices have also been developed to avoid use of costly pulley arrangements, while maintaining ease of use. In devices where the level of friction is relatively constant, to lower the window the frictional resistance can be overcome without undue difficulty since the weight of the window helps or complements the downward force applied by an operator. Raising the sash is another matter entirely, requiring the operator to overcome the frictional force of the device plus raising the weight of the window itself. Additionally, some positioning devices are not suitable for use on solid core doors since the pulley mechanisms are typically located in the hollow portion of the side frame members.

Some prior art devices have been known to either creep upward or downward from a selected position or else require substantial physical effort to overcome the frictional force of the positioning device. Solutions to overcome these difficulties have been restricted because of the limitations relating to cost while maintaining simplicity of construction and the requisite reliability of operation.

In a related problem, consumers request various flexible screens that can be extended across the window opening. The flexible screens can be blinds, bug screens, and the like. The flexible screens are typically not needed, however, when the sash is closed. Consumers prefer windows with both a clear view unobstructed by screens and the benefit of the screen when the sash is opened ventilation. One solution to satisfying these competing demands is to attach the free end of a flexible screen disposed on a spring-loaded roller to a window sash such that the screen unrolls to cover the window opening as the window is moved to the open position and rolls up as the window is closed. Examples of such retractable screen systems attached to a moveable window sash are disclosed in U.S. Pat. Nos. 1,039,411; 1,078,827; 2,261,443; 3,005,489; 3,911,990; 4,993,468; 5,544,689; 5,915,443; 6,136,186; and 6,167,936. These systems, however, operate independently from the mechanism used to retain the sash in a desired position.

### BRIEF SUMMARY OF THE INVENTION

The present invention relates to a retractable screen system adapted to provide a positioning force for moveable sash in a fenestration product.

In one embodiment of the present invention, a door is provided with vertical jambs having vertical channels. A window sash is movable in the vertical channels. A retractable screen assembly is attached to the door. The retractable screen assembly includes a roller, a flexible screen attached at a first end to the roller and at a second end to the movable window sash, and a biasing mechanism adapted to apply a continuous torque to the roller. The torque generates a positioning force on the window sash equal to at least 50% of the force of gravity acting on a window sash, such that the window sash can be positioned at an infinite number of locations along the vertical channels.

In another embodiment, the positioning force comprises at least 80% of the force of gravity acting on the window sash. The positioning force preferably substantially counterbalances the force of gravity acting on the window sash. The positioning force also applies a braking force on the window sash as it moves in a downward direction. The positioning force optionally includes a friction force acting between the window sash and the vertical channels. The friction force combines with the torque to retain the window sash in an infinite number of locations along the vertical channels. In one embodiment, the friction force comprises about 5% to about 20% of the force of gravity acting on the window sash.

The flexible screen is retracted when the window sash is moved from an open position to a closed position. The flexible screen is drawn across an opening formed when the window sash is in an open position. The edges of the flexible screen are releasably retained in the vertical channel when the window sash is in an open position.

In some embodiments, the door is a hollow or a solid core storm door. The window sash can be an upper or a lower window sash. The flexible screen is typically attached to a frame member on the window sash. The flexible screen can be one of a blind, a translucent film, a reflective film, or a bug screen. The biasing mechanism is typically a spring.

In one embodiment, a sash positioning device is attached to the window sash. The sash positioning device is releasably engagable with at least one a contact surface on the vertical channel, such that the sash positioning device can engage the vertical channel at an infinite number of locations. In another embodiment, the sash positioning device is attached to the vertical jambs. The sash positioning device and the positioning force cooperate to retain the window sash at an infinite number of location within the vertical channel.

The present invention is also directed to a door with a sash positioning device adapted to retain the window sash at any of an infinite number of locations along the vertical channels. A retraction mechanism acts on the roller to generate a continuous positioning force on the window sash having a magnitude of at least 20% of the force of gravity acting on a window sash, such that the window sash can be positioned at an infinite number of locations along the vertical channels. In other embodiments, the positioning force has a magnitude of about 40%, about 60%, or about 80% of the force of gravity acting on the window sash.

The present invention is also directed to a door with a window sash positioning device attached to the window sash that is releasably engagable with at least one contact surface on the vertical channel, such that the sash positioning device can engage the vertical channel at an infinite number of locations. The retractable screen assembly provides a continuous positioning force on the window sash.

The present invention is also directed to a method of operating a movable sash in a door. The method includes slidably engaging a window sash with vertical channels on vertical jambs. A first end of a flexible screen is attached to a roller and a second end to an edge of the window sash. A torque is applied to the roller. A continuous positioning force is applied to the window sash. The positioning force equal to at least 50% of the force of gravity acting on a window, sash such that the window sash can be positioned at an infinite number of locations along the vertical channels.

In some embodiments, the positioning force includes a friction force between the window sash and the vertical channels. The friction force is preferably equal to about 5% to about 20% of the force of gravity acting on the window sash. The positioning force is preferably equal to about 80% of the force of gravity acting on the window sash. The positioning force preferably substantially counterbalances the force of gravity acting on the window sash. The positioning force also applies a braking force on the window sash as it moves in a downward direction.

The method can also include attaching a window sash positioning device to the window sash and/or the vertical jambs. The sash positioning device releasably engages at least one contact surface on the vertical channel and/or the window sash, such that the sash positioning device can engage the vertical channel at an infinite number of locations.

In present invention also includes a method of operating a movable sash in a door including releasably engaging the sash positioning device with a at least one contact surface on the vertical channel, such that the sash positioning device can engage the vertical channel at an infinite number of locations. A first end of a flexible screen is attached to a roller and a second end to an edge of the window sash. A torque is applied to the roller. The torque generates a positioning force having a magnitude of at least 20% of the force of gravity acting on a window sash, such that the window sash can be positioned at an infinite number of locations along the vertical channels. In other embodiments, the positioning force has a magnitude of about 40%, about 60%, or about 80% of the force of gravity acting on the window sash.

The present invention is also directed to a method of operating a window assembly comprising the steps of moving an engaging member on a window sash positioning device to a disengaged position. The window sash is moved to one of an infinite number of positions along a vertical channel. A flexible screen attached to the window sash is positioned across an opening formed by movement of the window sash. A continuous positioning force is applied to the flexible screen. The positioning equal to at least 20% of the force of gravity acting on the window sash. The engaging member on the sash positioning device is engaged with a portion of the vertical channel to secure the window sash in one the infinite number of positions along the vertical channel.

### BRIEF DESCRIPTION OF THE SEVERAL VIEWS OF THE DRAWING

FIG. 1 is a front fragmentary view of a portion of a sash positioning device mounted on a window sash in accordance with the present invention.

FIG. 1a is a front view of a storm door with the sash positioning device of FIG. 1.

FIG. 2 is a top view of a portion of the window sash with a sash positioning device in accordance with the present invention.

FIG. 3 is a cross-sectional view of the window sash of FIG. 1 taken along the line 3-3.

FIGS. 4a-4e illustrate various internal views of the sash positioning device of FIG. 2.

FIGS. 5a-5b illustrate various views of an alternate sash positioning device in accordance with the present invention.

FIG. 6a is a side view of an engaging member of the sash positioning device positioned in a disengaged position within a vertical jamb channel of a window assembly.

FIG. 6b is a side view of an engaging member positioned in a partially engaged position within a vertical jamb channel of a window assembly.

FIG. 6c is a side view of an engaging member positioned in an engaged position within a vertical jamb channel of a window assembly.

FIG. 6d is a cross-sectional view of the force acting on the vertical jamb channel.

FIG. 7a is a perspective view of an arm of the sash positioning device and an engaging member attached to the arm.

FIG. 7b is a side view of the arm and the engaging member attached to the arm.

FIG. 8a is a perspective view of a base plate of the sash positioning device.

FIG. 8b is a top view of a base plate of the sash positioning device.

FIG. 8c is a bottom view of a base plate of the sash positioning device.

FIG. 8d is a side view of a base plate of the sash positioning device.

FIG. 9 is a schematic sectional view of an alternative embodiment of a sash positioning device of the present invention.

FIG. 10a is a perspective view of an engaging member for use with the sash positioning device of FIG. 9.

FIG. 10b is a perspective view of an alternate engaging member for use with the sash positioning device of FIG. 9.

FIG. 10c is a schematic sectional view of a window assembly with the engaging member of FIG. 10a mounted on the window sash.

FIG. 10d is a cross-sectional view of the window assembly of FIG. 10c taken along the line 10d-10d.

FIG. 10e is a perspective view of the window assembly of FIG. 10c.

FIG. 11a-11d illustrate an alternative sash positioning device in accordance with the present invention.

FIG. 12a is a perspective view of an alternative embodiment of an arm.

FIG. 12b is a schematic view of location of biasing forces that an engaging member of the arm of FIG. 12a acts on a vertical jamb channel.

FIG. 13a is a perspective view of another alternative embodiment of an arm.

FIG. 13b is a schematic view of location of biasing forces that an engaging member of the arm of FIG. 13a acts on a vertical jamb channel.

FIG. 13c is a schematic sectional view of a window assembly with the arm of FIG. 13a mounted on the window sash.

FIG. 13d is a cross-sectional view of the window assembly of FIG. 13c taken along the line 13d-13d.

FIG. 13e is a perspective view of the window assembly of FIG. 13c.

FIG. 13f is a front view of the window assembly of FIG. 13c.

FIG. 14a is a perspective view of a portion of a window assembly with a sash positioning device mounted on a jamb channel.

FIG. 14b is a top sectional view of FIG. 14a.

FIG. 14c is a side sectional view of FIG. 14a.

FIG. 15a is a front view of a hollow core door with the sash positioning device of FIG. 1 and a retractable screen assembly in accordance with the present invention.

FIG. 15b is a front view of a solid core door with the sash positioning device of FIG. 1 and a retractable screen in accordance with the present invention.

FIG. 15c is a front view of a door with a retractable screen assembly in accordance with the present invention.

FIG. 16a is a cross-sectional view of the storm door of FIG. 15a taken along line 16a-16a.

FIG. 16b is a cross-sectional view of the storm door of FIG. 15b taken along line 16b-16b.

FIG. 16c is a cross-sectional view of the storm door of FIG. 15c taken along line 16c-16c.

FIG. 17a is a cross-sectional view of the storm door of FIG. 15a taken along line 17a-17a.

FIG. 17b is a cross-sectional view of the storm door of FIG. 15b taken along line 17b-17b.

FIG. 17c is a cross-sectional view of the storm door of FIG. 15c taken along line 17c-17c.

FIG. 18a is a cross-sectional view of the storm door of FIG. 15a taken along line 18a-18a.

FIG. 18b is a cross-sectional view of the storm door of FIG. 15b taken along line 18b-18b.

FIG. 18c is a cross-sectional view of the storm door of FIG. 15c taken along line 18c-18c.

FIG. 19a is a perspective view of a retractable screen mechanism in according with the present invention.

FIG. 19b is a perspective view of an alternate retractable screen mechanism in according with the present invention.

FIG. 20a is a cross-sectional view of a screen attachment member taken along the line 20a-20a of FIG. 15a.

FIG. 20b is a cross-sectional view of a screen attachment member taken along the line 20b-20b of FIG. 15b.

FIG. 20c is a cross-sectional view of a screen attachment member taken along the line 20c-20c of FIG. 15c.

FIG. 21a is a cross-sectional view of a screen attachment member taken along the line 21a-21a of FIG. 15a.

FIG. 21b is a cross-sectional view of a screen attachment member taken along the line 21b-21b of FIG. 15b.

FIG. 21c is a cross-sectional view of a screen attachment member taken along the line 21c-21c of FIG. 15c.

FIG. 21d is a cross-sectional view of a screen attachment member taken along the line 21d-21d of FIG. 15c.

FIG. 22 is a fragmentary perspective view of a roller and a biasing mechanism in accordance with the present invention.

FIG. 23 is schematic cut-away view of the roller of FIG. 22.

FIG. 24a illustrates the operation of the upper sash and retractable screen assembly of FIG. 15a in accordance with the present invention.

FIG. 24b illustrates the operation of the upper sash and retractable screen assembly of FIG. 15b in accordance with the present invention.

FIG. 25 illustrates the operation of the lower sash and retractable screen assembly of FIG. 15b in accordance with the present invention.

### DETAILED DESCRIPTION OF THE INVENTION

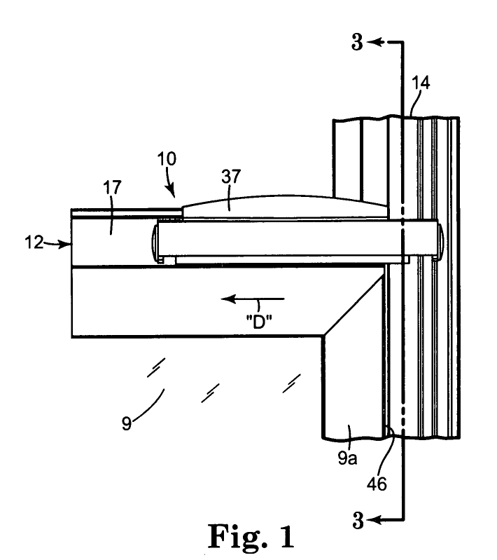

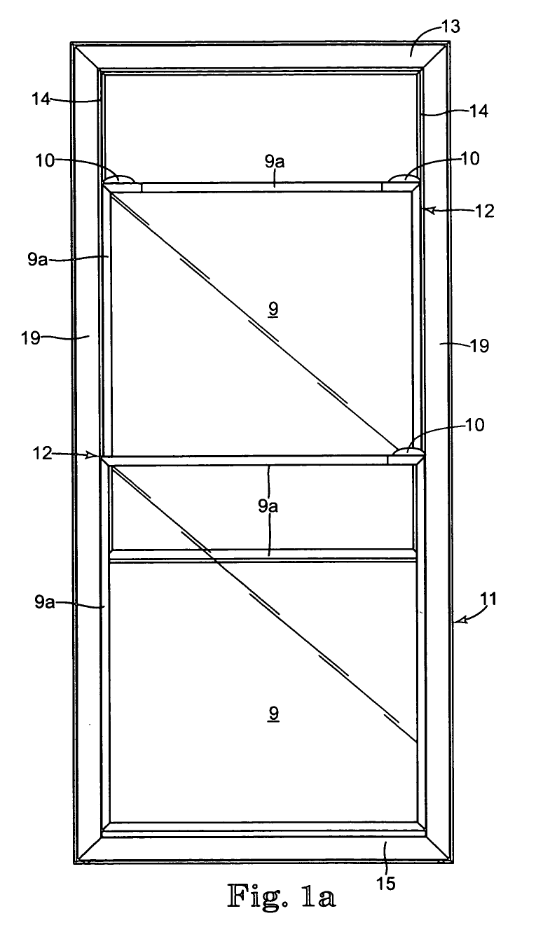

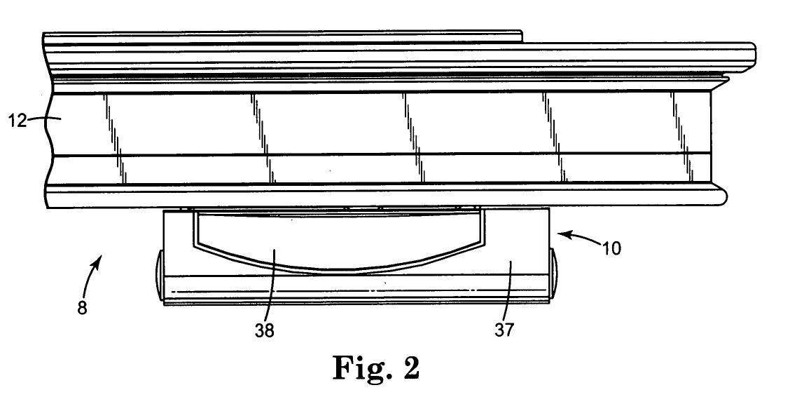

FIGS. 1, 1a and 2 illustrate various views of window pane 9 bordered by frame members 9a to form window sash 12 for fenestration product 11, such as a door or window. The window sash 12 is slidably mounted in a pair of vertical jamb channels 14 on frame members 19 of the fenestration product 11.

The spatial relationship of the vertical jamb channels 14 is maintained by a top rail 13 and a bottom rail 15. As best seen in FIG. 1a, the fenestration product 11 includes a pair of window sashes 12.

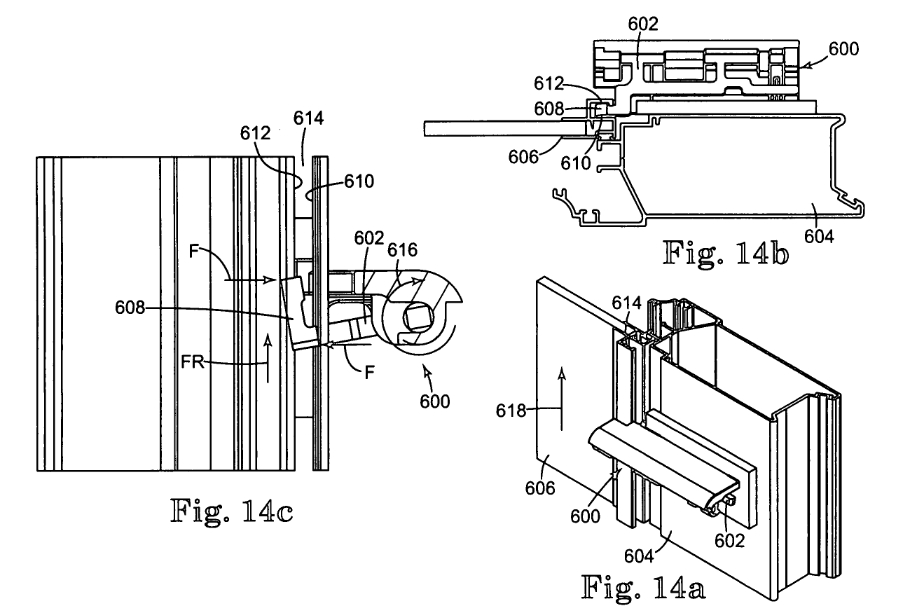

Each moveable window sash 12 is equipped with at least one sash positioning device 10. In the illustrated embodiment, the sash positioning device 10 is mounted to a wall 17 of window sash 12, although any of the surfaces can be used. Alternatively, in the embodiment of FIGS. 14a-14c, the sash positioning device is mounted on the doorjamb. As used herein, the “sash positioning device” refers to a mechanism that holds a movable window sash stationary within a vertical jamb channel of a window assembly in any desired position within a specific range of motion. The range of motion is typically the entire range of motion of the window sash, but can be some subset of that range of motion.

In the embodiment of FIG. 1a, the upper sash 12 includes two sash positioning devices 10 and the lower sash 12 includes only one positioning device 10. In another embodiment, two sash positioning devices 10 are used on each sash 12, one adjacent to each vertical jamb channel 14. Since the sash positioning devices 10 are identical in construction, except that they are mirror images of each other for right and left hand use, only one will be described in detail below.

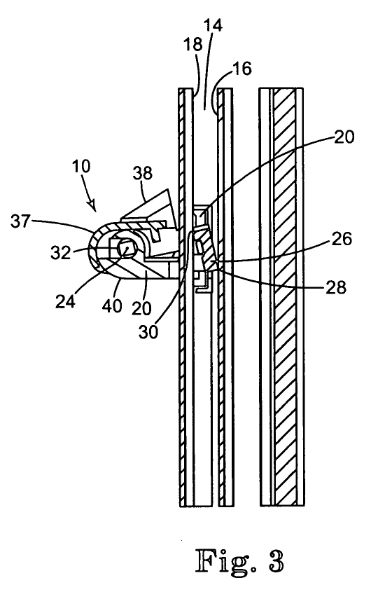

In the embodiment of FIG. 3, a cross-sectional view of the window assembly of FIG. 1 taken along the line 3-3, the sash positioning device 10 extends into and engages a portion of the vertical jamb channel 14 to provide a bi-directional force, such that the window sash 12 can be easily raised or lowered and yet will reliably maintain a desired position. As shown in FIG. 3, the vertical jamb channel 14 is preferably formed of an integral piece of extruded material, such as aluminum or other metals. The channel 14 includes first and second vertical contact surfaces 16, 18. The vertical contact surfaces 16, 18 are configured so as to serve as guides for the window sash 12 as it is raised and lowered. In the illustrated embodiment, the vertical contact surfaces 16, 18 are parallel to the window pane 9. Preferably, the vertical contact surfaces 16, 18 extend along the entire range of motion of the window sash 12 in the jamb channel 14.

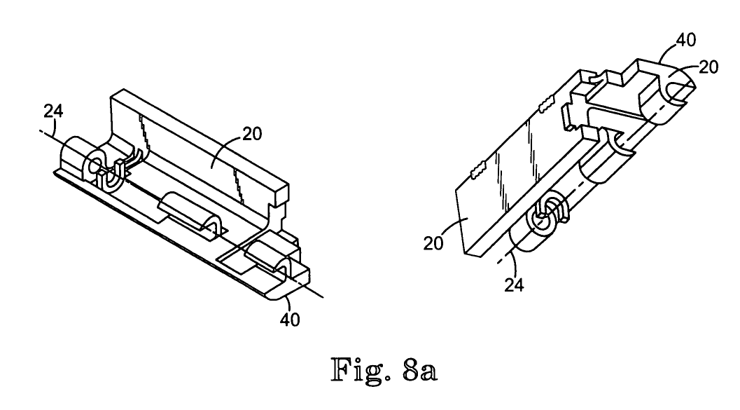

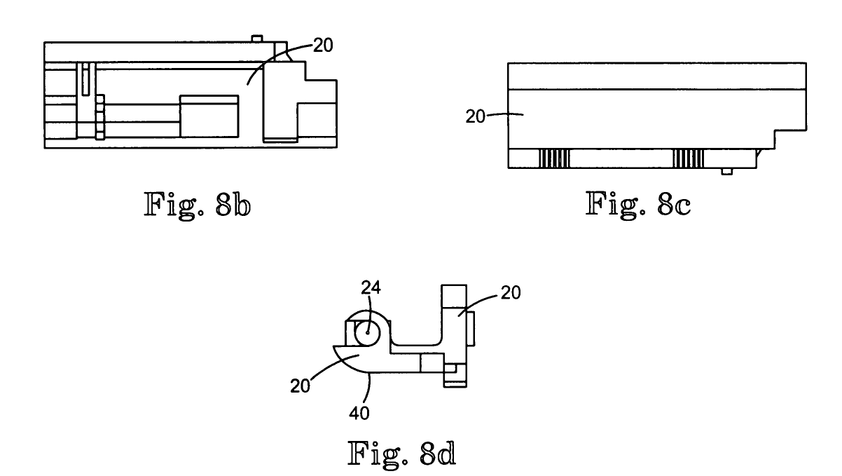

The base plate 20, which is separately shown in FIGS. 8a-8d, is fixedly attached to the wall 17 of the window sash 12 (see FIG. 1). In another embodiment, the sash positioning device 10 can be located near the lower portion of the sash 12. In another embodiment, the base plate 20 is integrally formed as part of the sash 12. For example, the sash 12 can be molded to include the base plate 20 and other portions of the sash positioning device 10.

The arm 22 is pivotally mounted to the base plate 20 and is pivotable around an axis 24. The axis 24 is preferably parallel to the first and second vertical contact surfaces 16, 18 of the channel 14. The axis 24 is preferably located outside a region bounded by the first and second vertical contact surfaces 16, 18. The sash positioning device 10 is adapted to engage with the first and second vertical contact surfaces 16, 18 to hold the window sash 12 in a desired position.

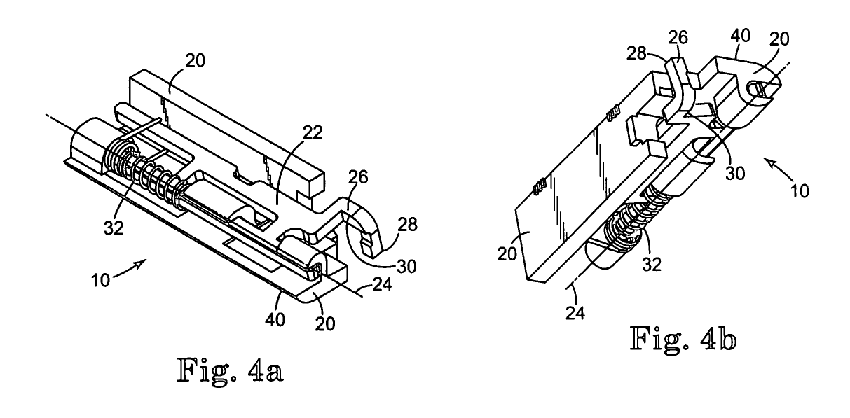

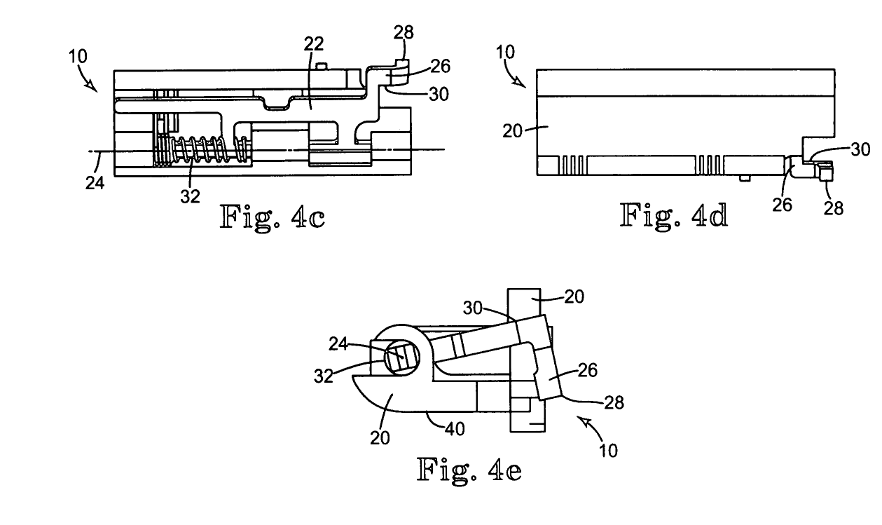

The arm 22 (see also FIG. 4a) and actuator 37 are preferably a single, unitary component, rather than two separate components. The actuator 37 preferably includes a first gripping surface 38 and second gripping surface 40 on the base plate 20. The actuator 37 is the interface between the sash positioning device 10 and the operator used to move engaging member 26 from the engaged to the disengaged position. The first and second gripping surfaces 38, 40 are adapted to receive an external force that pivots the arm 22 around the axis 24. The external force is preferably a compressive force generated by fingers of an operator.

When an external compressive force is applied to the first and second gripping surfaces 38, 40, the arm 22 pivots about the axis 24 toward the base plate 20 in opposition to the biasing force generated by the biasing member 32. Conversely, when the external compressive force is released, biasing member 32 causes the arm 22 to pivot away from the base plate 20. In another embodiment, the arm 22 is attached to the base plate 20 at two discrete locations with two separate axes of rotation. In another embodiment, the sash positioning device 10 is moved to the disengaged position manually, without the assistance of the biasing member 32.

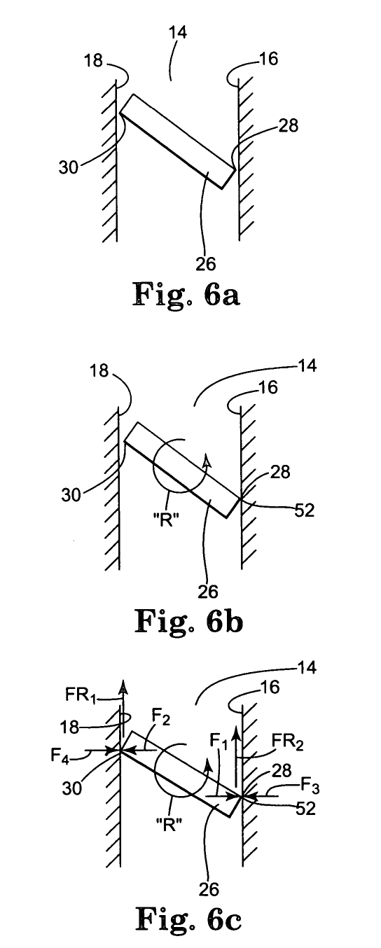

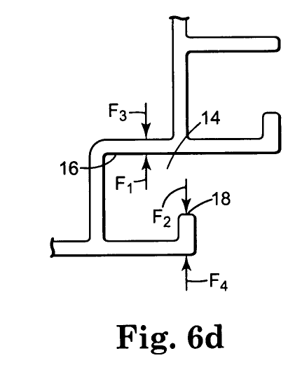

The engaging member 26 of the sash positioning device 10 is fixedly attached to the arm 22. The engaging member 26 is preferably positioned in or near the vertical jamb channel 14. In the illustrated embodiment, the engaging member 26 includes first and second contact regions 28, 30 (see FIG. 6a). When the external compressive force is applied to the first and second gripping surfaces 38, 40, the arm 22 pivots toward the base plate 20. Meanwhile, the engaging member 26 pivots to a disengaged position.

In one embodiment, the engaging member 26 is constructed from a harder material than the first and second contact surfaces 16, 18. Consequently, the engaging member 26 plastically deforms the surfaces 16, 18 when in the engaged position. In another embodiment, the engaging member 26 is constructed from a softer material than the first and second contact surfaces 16, 18. In another embodiment, the engaging member 26 is constructed from the same material as the first and second contact surfaces 16, 18. In another embodiment, the engaging member 26 and/or the contact surfaces 16, 18 can be coated with a friction coating, such as a polymeric material, to increase or decrease the frictional constants.

The sash positioning device 10 of FIGS. 2 and 3 is shown in greater detail in FIGS. 4a-4e with the actuator 37 removed. In the illustrated embodiment, the sash positioning device 10 includes a base plate 20 coupled to an arm 22, a biasing member 32, and an engaging member 26. The biasing member 32 of the sash positioning device 10 is a torsional spring adapted to bias the arm 22 to the base plate 20. The biasing member 32 generates not only an axial force along the axis 24, but also a pivoting force about the axis 24. In another embodiment, two separate biasing members can be used to generate the axial force and the pivoting force. Although a torsional spring is the preferred biasing member 32, a variety of other structures can be used, such as a leaf spring, an elastomeric material, etc. The biasing member 32 can optionally be omitted in favor of manual engagement and disengagement of the positioning device 10.

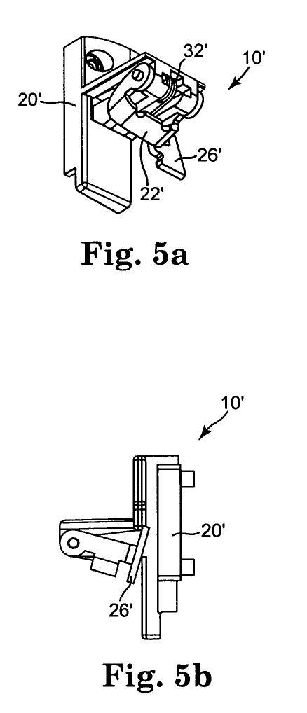

FIGS. 5a-5b illustrate an alternate sash positioning device 10′ in accordance with the present invention. The sash positioning device 10′ includes a base plate 20′ coupled to an arm 22′, a biasing member 32′, and an engaging member 26′. The biasing member 32′ of the sash positioning device 10′ is a torsional spring. The engaging member 26′ is preferably located in the vertical jamb channel 14 and the base plate 20′ is then attached to the window sash 12 (see FIG. 1). Alternatively, the engaging member 26′ is located in the vertical channel 614 on the window sash 606 and then attached to the frame 604 (see FIG. 14a).

As best illustrated in FIG. 6a, in the disengaged position the first and second contact regions 28, 30 are free or substantially free from contacting with the first and second contact surfaces 16, 18 of the vertical jamb channel 14. The window sash 12 can then be raised or lowered to a desired position. As used herein, “substantially free from contact” refers to no contact between contact regions and surfaces on the jamb or minimal contact such that the forces are extremely low compared to the force of gravity on the window sash.

After the window sash 12 is raised or lowered to a desired position, the operator releases the external compressive force on the actuator 37. The pivoting force generated by the biasing member 32 pivots the arm 22 away from the base plate 20. In the meantime, the biasing member 32 starts to bias the engaging member 26 from the disengaged position toward an engaged position. As shown in FIG. 6b, the first contact region 28 is biased into engagement with the first contact surface 16 at a pivot region 52. Thereafter, the weight of the sash 12 causes pivoting of the engaging member 26 about the pivot region 52 in a direction “R”, so that the second contact region 30 is in engagement with the second contact surface 18, as illustrated in FIG. 6c. Alternatively, the second contact region 30 of the engaging member 26 could initially engage with the second contact surface 18. The first contact region 28 of the engaging member 26 would then engage with the first contact surface 16.

As illustrated in FIG. 6c, the pivoting force generated by the biasing member 32 alternatively pivots the arm 22 away from the base plate 20 so that the first contact region 28 is biased into engagement with the first contact surface 16 at about the same time as the second contact region 30 is in engagement with the second contact surface 18. That is, the engaging member 26 moves from the disengaged position of FIG. 6a to the engaged position of FIG. 6c, without the intermediate configuration of FIG. 6b.

In yet another embodiment illustrated in FIG. 6c, the operator manually moves the arm 22 away from the base plate 20 so that the engaging member 26 is moved toward the engaged position. Once the first contact region 28 is biased into engagement with the first contact surface 16, the weight of the sash 12 causes further movement of the engaging member 28 about the pivot region 52 so that the second contact region 30 is in engagement with the second contact surface 18.

As illustrated in 6d, the first and second contact surfaces 16 and 18 are preferably part of a unitary structure such as a metal extrusion. The resiliency of the jamb channel 14 provides the forces F3 and F4 that oppose or counteract the forces F1 and F2 (referred to collectively as “F”) generated by the engaging member 26. Consequently, the forces “F” do not act to displace the vertical jamb channels 14. The forces F create frictional forces FR1 and FR2 that support the window sash 12 until released by the operator as discussed above. The frictional forces FR1 and FR2 are proportional to the forces F.

Turning back to FIG. 6c, when the first and second contact regions 28, 30 are engaged with the first and second contact surfaces 16, 18, the weight of the sash 12 acts to maintain the first and second contact regions 28 and 30 in engagement with the first and second contact surfaces 16 and 18, respectively. Since the axis 24 (see FIG. 3) is located outside of the space defined by the first and second contact surfaces 16, 18, the weight of the sash 12 acts to rotate the engaging member 26 in a direction “R”, further increasing the force F. The greater the weight of the sash 12, the greater the force “F” generated at the contact regions 28, 30. If an additional downward force is applied to the sash 12, such as by the operator, the force “F” at the contact regions 28, 30 increases to compensate. Consequently, the forces “F” are self-compensating. As used herein, “self-compensating” refers to a change in the forces F in proportion to a change in the downward force on the window sash.

Forces “F” act at the interface between the contact regions 28 and 30 and the first and second contact surfaces 16 and 18 of the vertical jamb channel 14, respectively. Since friction is a function of the force times a frictional constant (dependent on the materials at the interface), the magnitude of the frictional forces FR1 and FR2 can be engineered by changing the shape of the contact regions 28, 30 and/or selection of materials forming the engaging member 26 and the first and second contact surfaces 16, 18.

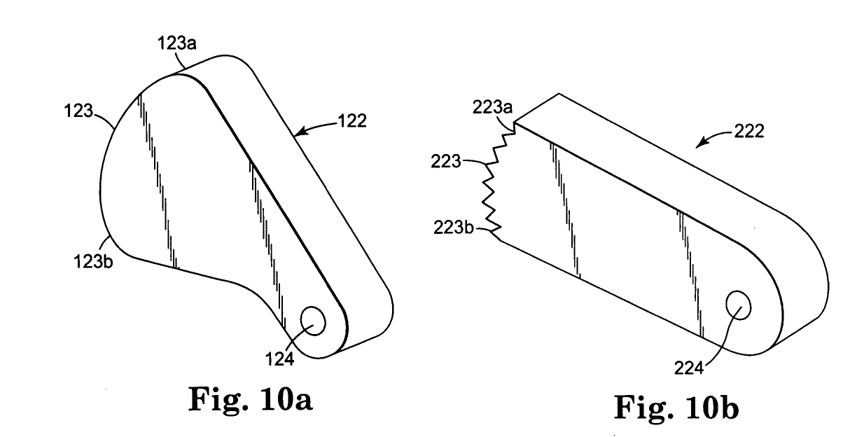

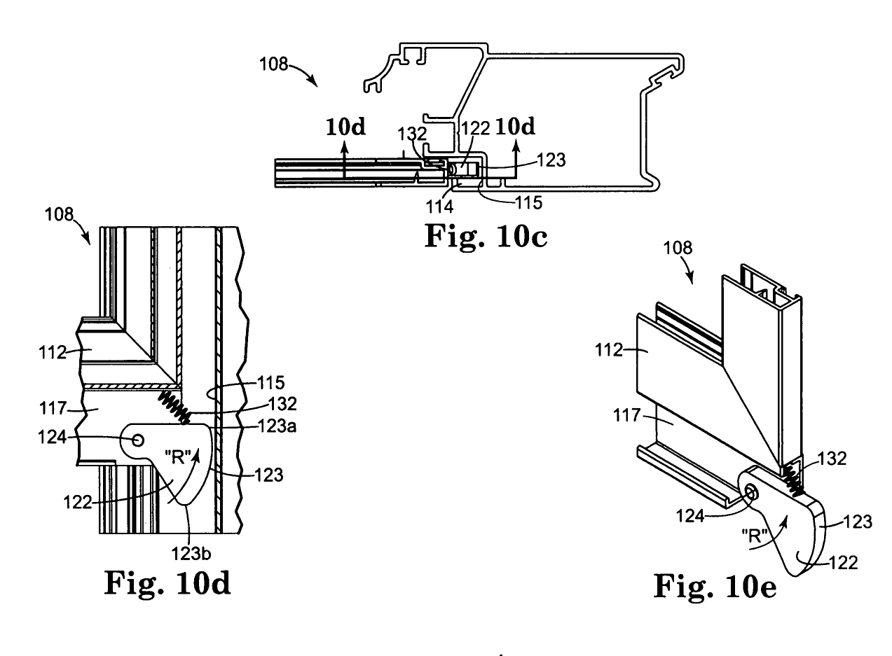

The geometry of the engaging member 26 and/or the geometry of the contact surfaces 16 and 18 can greatly influence the frictional forces FR1 and FR2. For example, an engaging member 26 with an increasing radius increase the forces F as it progressively engages with the contact surfaces 16 and 18. (See e.g., the cam-shaped engaging member in FIGS. 10c-10e). Shifting the location of the axis 24 can also have a substantial impact on the forces F.

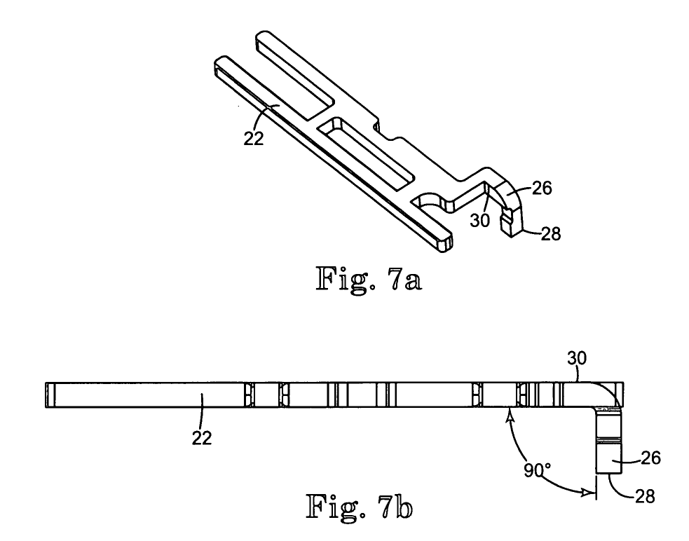

Referring now to FIGS. 7a and 7b, the first contact region 28 of the engaging member 26 preferably includes a first line contact with the first contact surface 16 of the vertical jamb channel 14. Similar to the first contact region 28, the second contact region 30 preferably includes a second line contact with the second contact surface 18 of the vertical jamb channel 14. As used herein, the “line contact” refers to a narrow, elongated, and generally straight interface between a contact region and an contact surface. While a “line” technically does not have a width, the line contact of the present invention typically has a width of less than about 1 millimeter. In one embodiment, the first and second line contacts are parallel to the axis 24 and perpendicular to a direction of travel of the window sash 12. In another embodiment, the line contacts are neither parallel to the axis 24 nor perpendicular to the direction of travel of the window sash 12. The dimension (e.g., surface area of engagement) of the first and second line contacts can be either equal or unequal.

In an alternative embodiment, the first contact region 28 includes a first point contact with the first contact surface 16. Similar to the first contact region 28, the second contact region 30 may alternatively include a second point contact with the second contact surface 18. As used herein, “point contact” refers to a relatively small contact region with a maximum dimension of about 1 millimeter. The point contact can be circular or any number of other regular or irregular shapes.

In another alternative embodiment, the first contact region 28 includes a first edge of two adjacent surfaces of the engaging member 26. The shape of the first edge that engages with the first contact surface 16 at one or more points is curvilinear. Similar to the first contact region 28, the second contact region 30 includes a second edge of two adjacent surfaces of the engaging member 26. The shape of the second edge is curvilinear that engages with the second contact surface 18 at one or more points. The dimensions (e.g., surface area of engagement) of the first and second edges can be either equal or unequal.

The shapes of the first and second contact regions 28, 30 can be the same or different. The first and second contact region shapes can be any combination of the various shapes discussed above. For example, in one embodiment, the first contact region is a line contact while the second contact region is a point contact.

Referring back to FIGS. 1 and 1a, the sash positioning device 10 permits the window sash 12 to be removed from, or inserted into, the fenestration product 11. The window sash 12 includes a perimeter 46 around the edges of the sash 12. When the window sash 12 is maintained in a desired position, the engaging member 26 is located outside the perimeter 46 of the window sash 12, and hence, is actively engaged with the vertical channel 14. To remove the window sash 12, the engaging member 26 is displaced in a direction “D” substantially within the perimeter 46 so that it is disengaged from the vertical channel 14. The window sash 12 can then be installed in, or removed from, the fenestration product 11. In another embodiment, the engaging member 26 is displaced in the direction “D” an amount sufficient to disengage from the vertical channel 14, even though the engaging member 26 is not entirely within the perimeter 46 of the sash 12.

An external force is preferably applied to overcome the axial force generated by the biasing member 32, so as to displace engaging member 26 within the perimeter 46. The external force is preferably generated by fingers of an operator in the direction “D”. A biasing member, such as the biasing member 32, generates an axial force in the direction opposite “D” so that the engaging member 26 is nominally engaged with the vertical channels 14.

In another embodiment, the engaging member 26 of the sash positioning device 10 is positioned in the vertical channel 14 and then mounted to the window sash 12. This embodiment does not require a sash positioning device 10 with the ability to displace in the direction D.

The sash positioning device 10 is easy to operate. A preferred method for positioning a movable window sash 12 in one or more vertical channels 14 using the sash positioning device 10 of the type includes the following steps. An external force applied by the operator is applied to the actuator 37 to pivot the engaging member 26 of the device 10 from an engaged position to a disengaged position. The window sash 12 is then repositioned to a desired position.

When the external compressive force is applied to the first and second gripping surfaces 38, 40, the arm 22 pivots toward the base plate 20. Meanwhile, the first and second contact regions 28, 30 of the engaging member 26 pivot about the axis 24. When pivoting about the axis 24, the first and second contact regions 28 and 30 pivot away from the first and second contact surfaces 16 and 18 of the vertical channel 14, respectively and simultaneously. The engaging member 26 moves from an engaged position to a disengaged position. In the disengaged position, as shown in FIG. 6a, the first and second contact regions 28, 30 are free or substantially free from contact with the first and second contact surfaces 16, 18 of the elongated vertical channel 14. Then, the window sash can be raised or lowered to a desired position. In another embodiment, the first and second contact regions 28, 30 contact the contact surfaces 16, 18 in the disengaged position, but the force is extremely low.

Alternatively, the operator can raise the window sash 12 without applying an external force to the actuator 37. The geometry of the engaging member 26 permits it to slide upward along the surfaces 16 and 18 with minimal friction. Consequently, the window sash 12 can be raised without applying a force to the actuator 37.

To position the window sash 12 as a particular location, the external force applied by the operator is released and the biasing member 32 pivots the engaging member 26 back into the engaged position. In another embodiment, the operator manually displaces the engaging member 26 back to the engaged position.

As shown in the embodiment of FIGS. 6b and 6c, releasing the external force to pivot the engaging member 26 back into the engaged position includes two steps. The first step is biasing a first contact region 28 of the engaging member 26 into engagement with the first contact surface 16. The second step is pivoting the engaging member 26 about the pivot region 52 under the weight of the window sash 12, so that a second contact region 30 engages with the second contact surface 18. When the first and second contact regions 28 and 30 respectively engage with the first and second contact surfaces 16 and 18, the weight of the sash acts on the first and second contact regions 28 and 30. The engaging member 26 is then positioned in the engaged position.

The sash positioning device 10 is easy to install on a movable window sash 12. A preferred method for installing the sash positioning device of the type includes the following four steps. The first step is fixedly attaching the base plate 20 of the sash positioning device 10 to the window sash 12. The base plate 20 is preferably attached to the wall 17 of the window sash 12. The axis 24 is preferably perpendicular to the direction of travel of the window sash 12. The engaging member 26 of the sash positioning device 10 is located outside the perimeter 46 of the window sash 12.

The second step is displacing the engaging member 26 of the sash positioning device 10 substantially into the perimeter 46 of the window sash 12. This step includes displacing the engaging member 26 against an axial force generated by the biasing member 32 along the axis 24. An external force is preferably applied to overcome the axial force. The external force is preferably generated by fingers of an operator along the direction of the axis 24.

The third step is pivoting the engaging member 26 into a disengaged position. This step includes pivoting the engaging member 26 against the pivoting force generated by the biasing member 32 about the axis 24. An external force is preferably applied to overcome the pivoting force. The external force is preferably a compressive force generated by fingers of an operator.

The final step is placing the engaging member 26 into the vertical channel 14 to bias the engaging member 26 toward an engaged position. The final step includes releasing the axial force generated by the biasing member 32 and the pivoting force generated by the biasing member 32. Although the above embodiments are discussed in terms of pivoting the engaging member 26, it is also possible to move the engaging member 26 relative to the contact surfaces 16, 18 with rotational and/or translational displacement. It is also not necessary for both contact regions 28, 30 to engage with the contact surfaces 16, 18. In some embodiments, a single contact region engages with a contact surfaces to create a frictional force FR sufficient to hold the sash in the desired location.

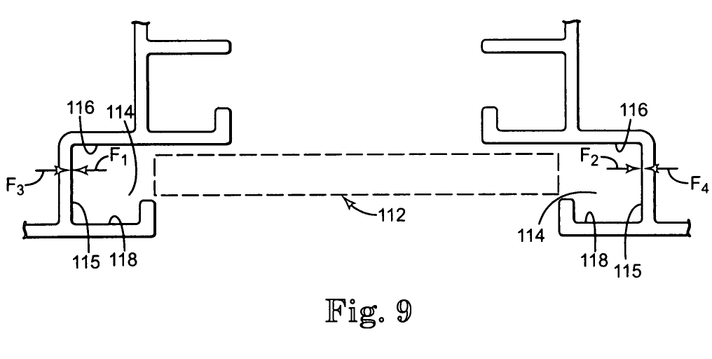

FIG. 9 illustrates an alternate embodiment of the present invention in which the engaging members (see e.g. FIG. 10d) act on opposing contact surfaces 115 located on opposite sides of window sash 112. The window assembly 108 is shown in phantom to illustrate its relationship with the vertical jamb channel 114. Forces F1 and F2 generated by the engaging members are opposed by forces F3 and F4 generated by the vertical jamb channel 114. The window assembly 108 acts as a compression member opposing the forces F1 and F2.

FIGS. 10a and 10b illustrate engaging members 122, 222 for use in the embodiment of FIG. 9. The engaging member 122 rotates around pivot point 124 so that generally smooth cam-shaped contact surface 123 engages with the surface 115 of the vertical jamb channel 114. In one embodiment, the contact surface 123 has a smaller radius in the region 123a than in the region 123b. Similar, the engaging member 222 rotates around pivot point 224 so that tooth surface 223 engages with the surface 115 of the vertical jamb channel 114. The radius of the surface 223 relative to the pivot point 224 preferably is greater in the region 223b than in the region 223a.

FIGS. 10c-10e illustrate a window assembly 108 with the engaging member 122 of FIG. 10a mounted on a wall 117 of a window sash 112. The embodiment of FIGS. 10c-10e can alternatively use the engaging member 222 of FIG. 10b. A biasing member 132 forces the engaging member 122 to rotate about the pivot point 124 in a direction “R” until the contact surface 123 of the engaging member 122 is in contact with the surface 115 of the vertical jamb channel 114. The weight of the window sash 112 then forces the engaging member 122 to rotate further in the direction “R” to tightly engage with the surface 115 of the vertical jamb channel 114. The engaging member 122 is forced against the surface 115 because the radius of the surface 123 relative to the pivot point 124 increases from the region 123a to the region 123b.

Preferably, the biasing member 132 is a torsional spring adapted to bias the engaging member 122. Although a torsional spring is the preferred biasing member 132, a variety of other structures can be used, such as a leaf spring, an elastomeric material, etc.

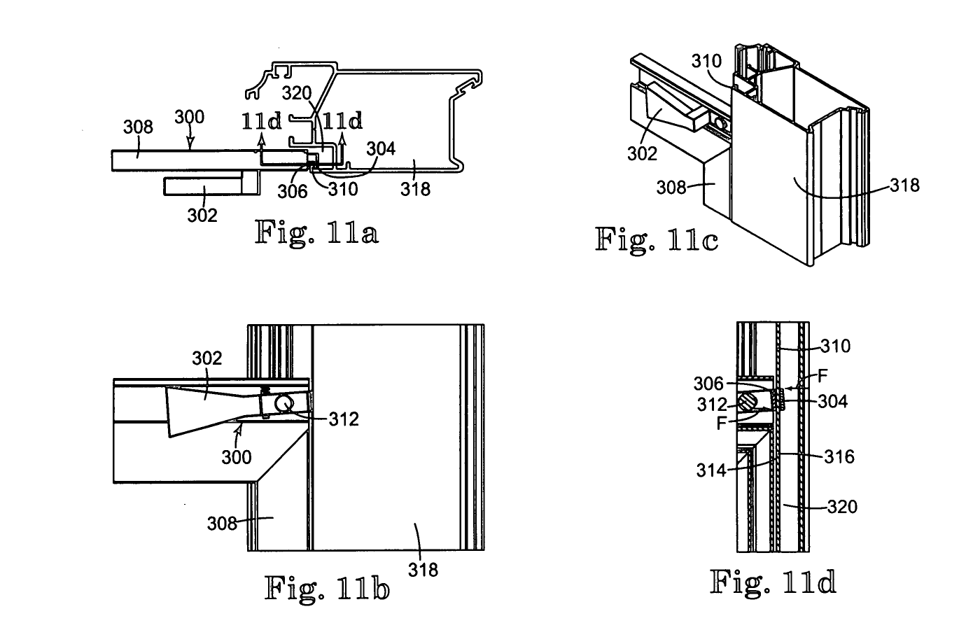

FIGS. 11a-11d illustrate an alternate sash positioning device 300 in accordance with the present invention. Actuator 302 with first and second engaging members 304, 306 is attached to the window sash 308. The first and second engaging members 304, 306 are positioned at the end of the actuator 302 and are generally parallel with each other. The first and second engaging members 304, 306 straddle member 310 of vertical channel 320. The actuator 302 rotates around pivot 312 so that the engaging members 304, 306 engage with surfaces 314, 316 of the member 310. Forces F act at the interface between the first and second engaging members 304, 306 and the surfaces 314 and 316, respectively, on the member 310. The pivot 312 is preferably a slot so that the engaging members 304, 306 can be disengaged from the member 310 to permit removal of the window sash 308 from the jambs 318.

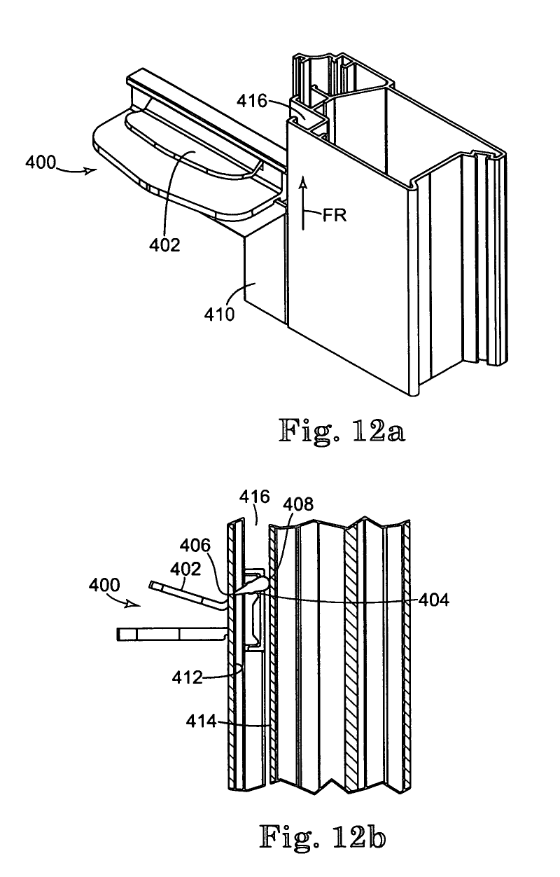

FIGS. 12a-12b illustrate an alternate sash positioning device 400 in accordance with the present invention. Actuator 402 includes a wedge-shaped engaging member 404 having first and second contact regions 406, 408 is attached to the window sash 410. The first and second contact regions 406, 408 engage with opposing surfaces 412, 414 of an vertical channel 416. Forces acting at the interface between the first and second contact regions 406, 408 and the surfaces 412, 414, respectively, create a friction force FR that retains the window sash 410 in the desired location.

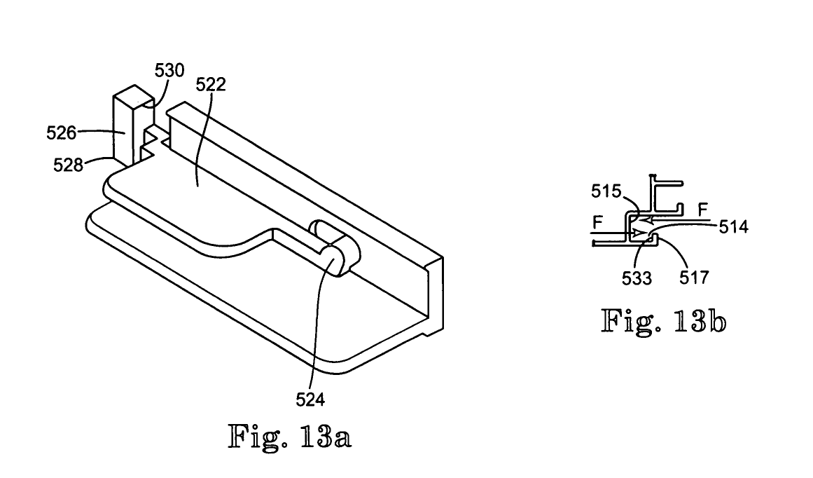

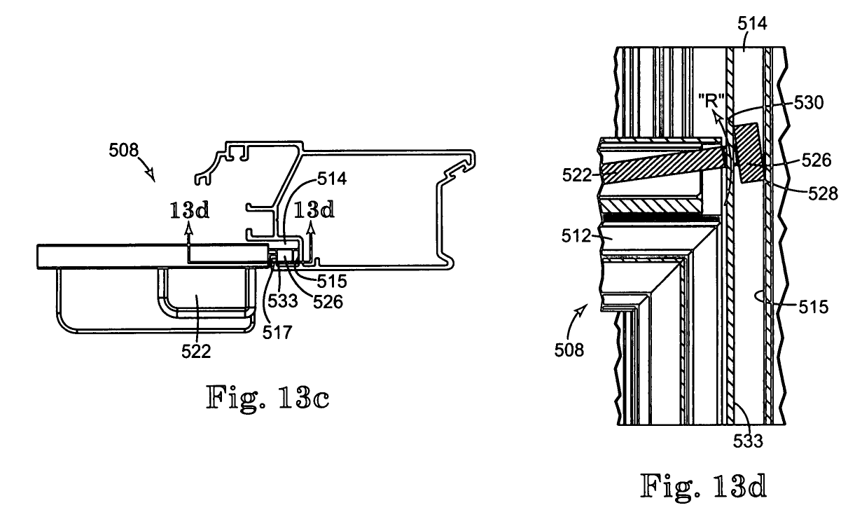

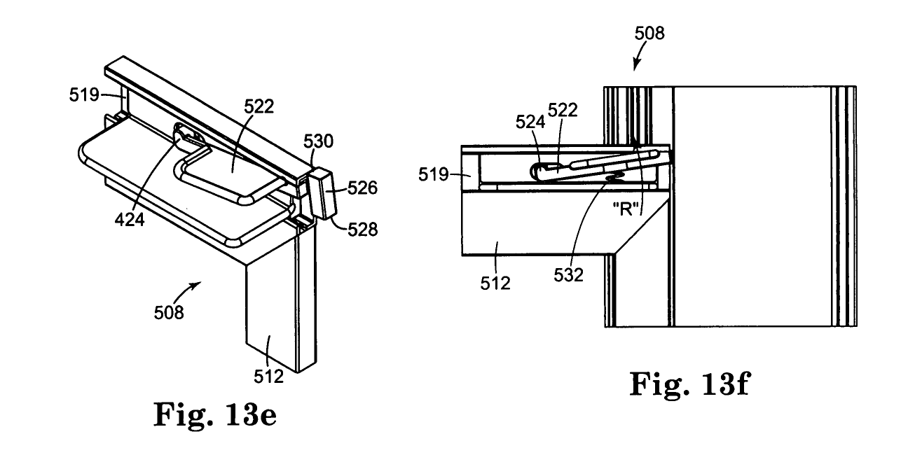

FIG. 13c-13f illustrate a sash positioning device 508 with the actuator 522 of FIG. 13a mounted on a wall 519 of window sash 512. FIG. 13a illustrates actuator 522 having an engaging member 526 attached thereon. The engaging member 526 has a generally cubical shape. FIG. 13b shows the engagement forces F generated at the interface between the engaging member 526 and contact surface 515 of an vertical channel 514 and an inner surface 533 of member 517. The forces F act at the interface between the first and second contact regions 528 and 530 of the engaging member 526 (FIG. 13d) and the contact surfaces 515 and 533 of the vertical channel 514, respectively.

A biasing member 532 optionally forces the engaging member 526 to rotate about the pivot point 524 in a direction “R” until the contact surface 528 of the engaging member 526 is in contact with the surface 515 of the vertical jamb channel 514. The weight of the window sash 512 then forces the engaging member 526 to rotate further in a direction “R” to tightly engage with the surface 533 of the vertical jamb channel 514. Preferably, the biasing member 532 is a compression spring adapted to bias the engaging member 526 into engagement with the surfaces 515, 533. Although a compression spring is the preferred biasing member 532, a variety of other structures can be used, such as a leaf spring, torsional spring, an elastomeric material, and the like.

FIGS. 14a-14c illustrate an alternate sash positioning device 600 generally as shown in FIGS. 4a-4e, except that the actuator 602 is attached to the frame 604 instead of the window sash 606. The sash positioning device 600 operates generally as illustrated in FIGS. 6a-6c. Any of the sash positioning devices disclosed herein can be substituted for the sash positioning device 600.

The engaging member 608 is positioned at the end of the actuator 602. The engaging member 608 engages with contact surfaces 610, 612 located on vertical channel 614 on window sash 606. The actuator 602 operates substantially as discussed in connection with FIGS. 4a-4e. Forces F act at the interface between the engaging member 608 and the surfaces 610, 612, respectively, to create frictional force FR that maintains the window sash 606 in the desired location.

In order to raise or lower the window sash 606, the operator rotates the actuator in the direction 616 to disengage the engaging member 608 from the surfaces 610, 612. The window sash 606 is then located in the desired position and the engaging member 608 is re-engaged with the surfaces 610, 612. Re-engagement can either be done by the operator or a biasing member. In one embodiment, the window sash 608 can be raised, but not lowered, by applying an upward force to the window sash 606 in the direction 618. The geometry and configuration of the engaging member 608 permits it to slide on the surfaces 610, 612 when the sash 606 is displaced in the direction 618.

Retractable Screen Feature

The present invention also relates to a retractable screen system for positioning a moveable sash on a fenestration product. The retractable screen extends and retracts across the opening created by movement of the sash. The retractable screen system provides a positioning force F that retains the moveable sash in a desired location. Once positioned, the moveable sash is retained at the desired location until acted on by an external force other than gravity. The retractable screen can be a blind, a translucent film, a reflective film, bug screen, or a variety of other structures. The present retractable screen system can be used alone or in combination with any of the infinite positioning devices disclosed herein.

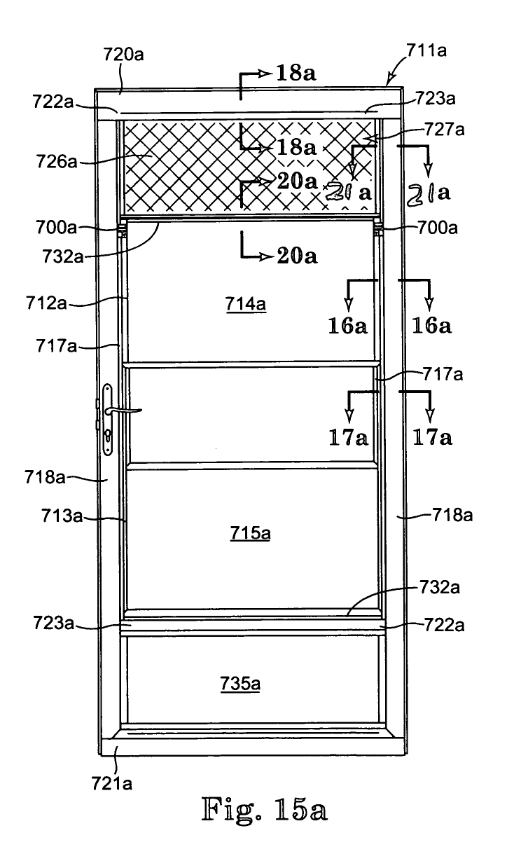

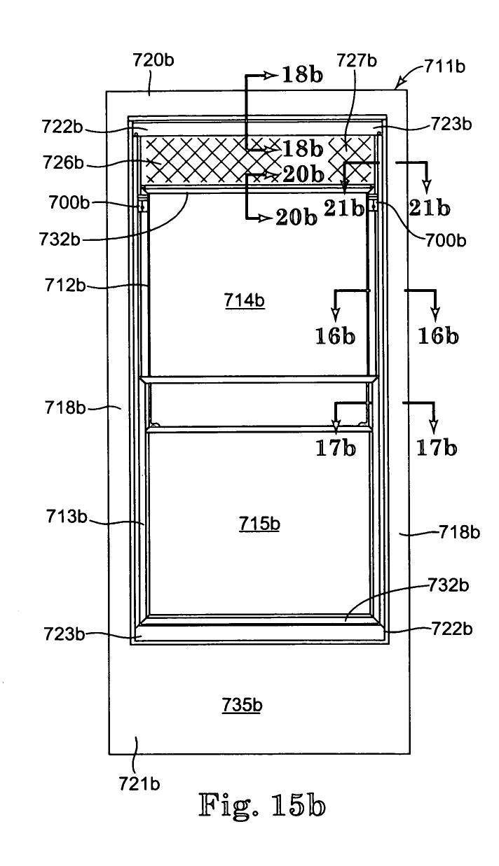

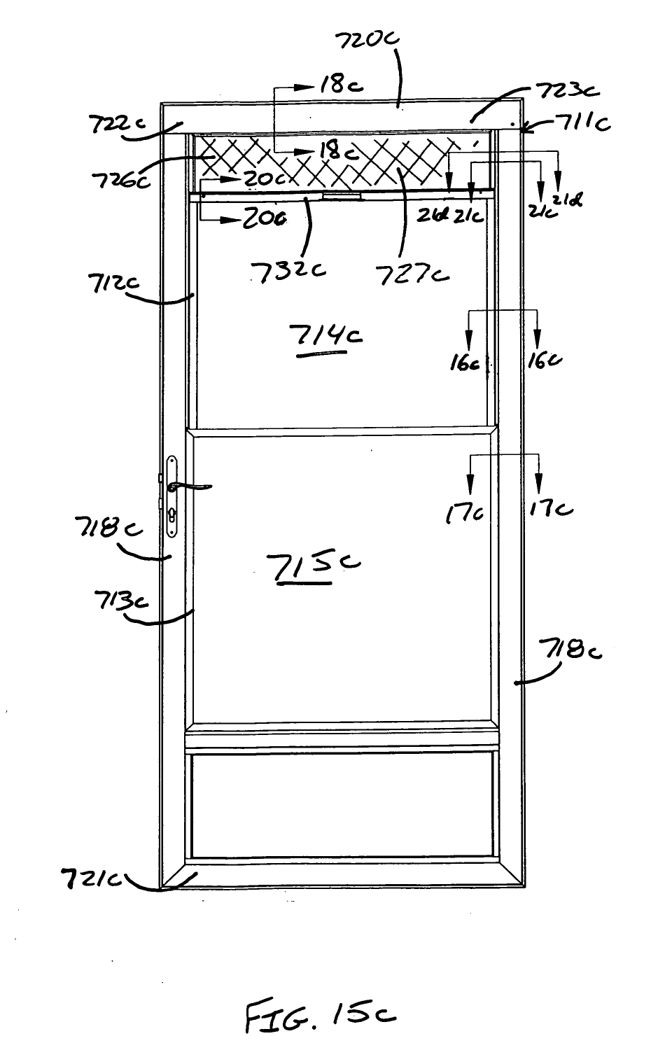

FIG. 15a illustrates door 711a having top rail 720a, bottom rail 721a, and a pair of vertical side frame members 718a. The rails 720a, 721a and frame members 718a are preferably extruded components. The door 711a is typically referred to as a hollow core door. In one embodiment, the door 722a is a storm door. Upper sash 712a and preferably also lower sash 713a slide vertically within channels on the vertical side frame members 718a. In another embodiment, the upper sash 712a is movable, while the lower sash 713a is fixed. The upper sash 712a includes a first pane 714a and associated components that move therewith. The lower sash 713a includes a second pane 715a and components that move therewith.

The upper sash 712a is optionally equipped with any of the sash positioning devices disclosed herein. Alternatively, a sash positioning device can be attached to the frame member 718a instead of the window sash 712a (see e.g., FIG. 14). By way of example only, a sash positioning devices 700a is provided adjacent to the side frame member 718a. The sash positioning device 700a is adapted to engage with the vertical contact surfaces of the vertical jamb channel 717a of the side frame member 718a to hold the upper sash 712a in the desired position. In the illustrated embodiment, a pair of sash positioning devices 700a are provided on the upper sash 712a, one adjacent to each of the side frame members 718a.

Top rail 720a of the door 711a includes a housing 722a that extends between the side frame members 718a. Retractable screen assembly 723a containing flexible screen 726a is located in the housing 722a. A free end of the flexible screen 726a is attached to window sash 712a. The phrase “flexible screen” or “screen” refer to bug screens made of wire, nylon or fabrics, transparent or opaque fabrics, blinds, or any flexible sheet material that can be stored on a roll.

As will be discussed below, as the window sash 712a is moved to the open position, the flexible screen 726a is dispensed from the retractable screen assembly 723a. As the window sash is moved to the closed position, the flexible screen 726a is retracted into the retractable screen assembly 723a. Example of such mechanisms are disclosed in U.S. Pat. Nos. 3,080,620, 3,788,006, 4,015,367, 4,570,382, 4,571,887,4,763,447, 4,779,380, and 5,033,235, which are hereby incorporated by reference.

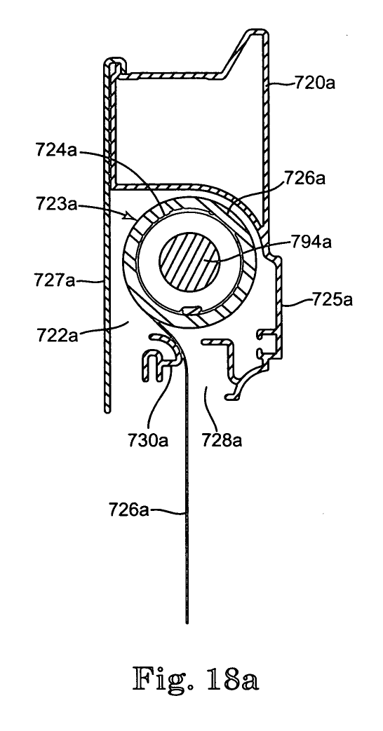

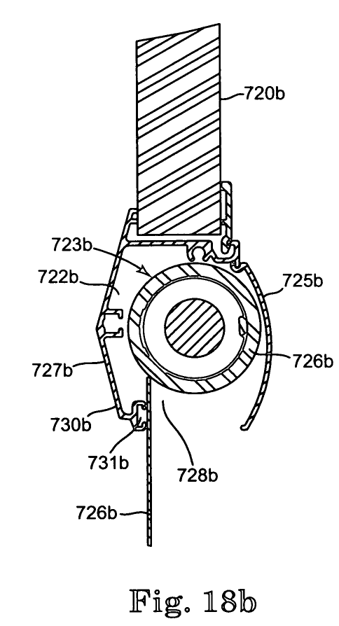

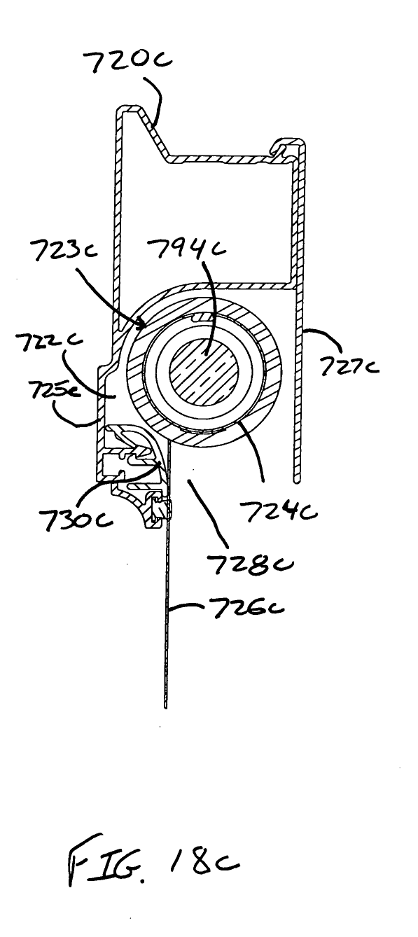

In another embodiment, a second retractable screen assembly 723a can optionally is located in housing 722a (see FIG. 18a) above kick panel 735a. Free end of the flexible screen 726a is attached to the bottom of the lower sash 713a. As the window sash 713a is moved upward to the open position, the flexible screen 726a is dispensed from the retractable screen assembly 723a. As the window sash 713a is moved downward to the closed position, the flexible screen 726a is retracted into the retractable screen assembly 723a.

FIG. 15b illustrates an alternate door 711b having top rail 720b, bottom rail 721b, and a pair of vertical side frame members 718b. The rails 720b, 721b and frame members 718b preferably have a solid core, typically of wood or foam. In one embodiment, the rails 720b, 721b and frame members 718b have a solid core that is at least partially covered with a layer or metal or polymeric cladding. In one embodiment, the door 711b is a storm door. The upper sash 712b is movable, while the lower sash 713b is moveable or fixed. The upper and lower sashes 712b, 713b include first and second panes 714b, 715b, respectively. The sashes 712b, 715b and/or the frame members 718b are optionally equipped with any of the sash positioning devices disclosed herein.

Housing 722b containing a retractable screen assembly 723b is attached to the top rail 720b. Retractable screen assembly 723b is preferably located in the housing 722b. The free end of the flexible screen 726b is attached to window sash 712b.

In another embodiment, a second housing 722b (see FIG. 18b) containing a second retractable screen assembly 723a is optionally attached to the door 711b above kick panel 735a. Free end of the flexible screen 726b is attached to the bottom of the lower sash 713b. As the window sash 713b is moved upward to the open position, the flexible screen 726 is dispensed from the retractable screen assembly 723b. As the window sash 713b is moved downward to the closed position, the flexible screen 726b is retracted into the retractable screen assembly 723b.

FIG. 15c illustrates an alternate door 711c having top rail 720c, bottom rail 721c, and a pair of vertical side frame members 718c. The rails 720c, 721c and frame members 718c preferably have a hollow core. The upper sash 712c is movable, while the lower sash 713c is moveable or fixed. The upper and lower sashes 712c, 713c include first and second panes 714c, 715c, respectively.

The sashes 712c, 715c and/or the frame members 718c are optionally equipped with any of the sash positioning devices disclosed herein. Housing 722c containing a retractable screen assembly 723c is attached to the top rail 720c and/or the frame members 718c. Retractable screen assembly 723c is preferably located in the housing 722c. The free end of the flexible screen 726c is attached to window sash 712c.

In one embodiment, the retractable screen assembly 723c provides the sole mechanism for positioning the upper sash 712c in the frame members 718c. In another embodiment, friction between the sash 712c and the side frame members 718c combines with the lifting force from the retractable screen assembly 723c to retain the sash 712c in the desired location. The amount of friction can be adjusted by selecting appropriate materials for the window sash 712c and the side frame members 718c. In one embodiment, the window sash 712c includes a polymeric member positioned to engaged with the jamb channels 717c.

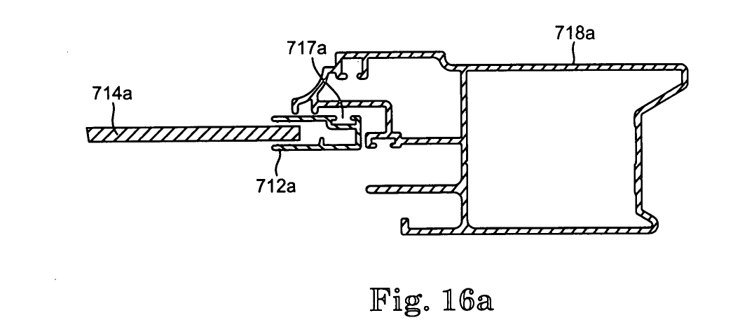

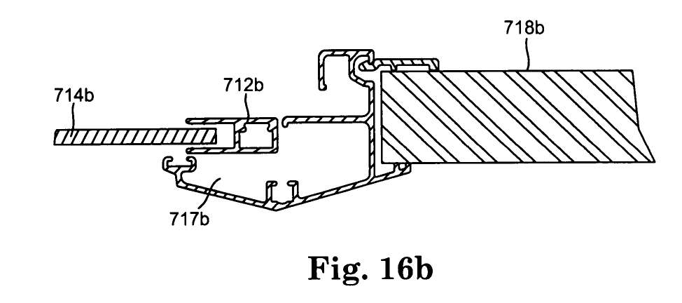

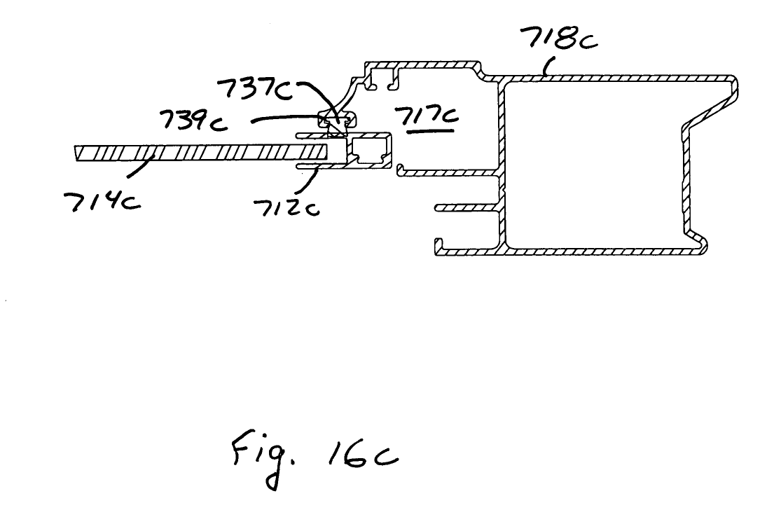

FIG. 16a is a cross-sectional view of the upper sash 712a, pane 714a, and the side frame member 718a of the door 711a taken along the line 16a-16a of FIG. 15a. The upper sash 712a is slidably mounted in a pair of vertical jamb channels 717a of the side frame members 718a. Since the two vertical jamb channels 717a are mirror images of each other, FIG. 16a shows only one vertical jamb channel 717a with the upper sash 712a mounted therein.

FIG. 16b is a cross-sectional view of the upper sash 712b, pane 714b and the side frame member 718b of the door 711b taken along the line 16b-16b of FIG. 15b. The upper sash 712b is slidably mounted in a pair of vertical jamb channels 717b of the side frame members 718b. In the illustrated embodiment, the extrusion forming the jamb channels 717b is attached to the solid side frame 718b.

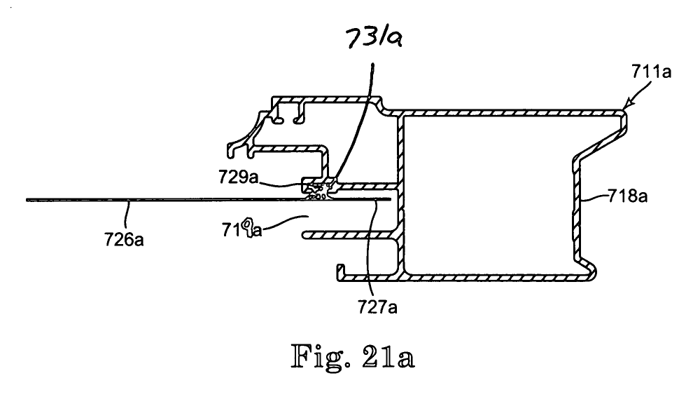

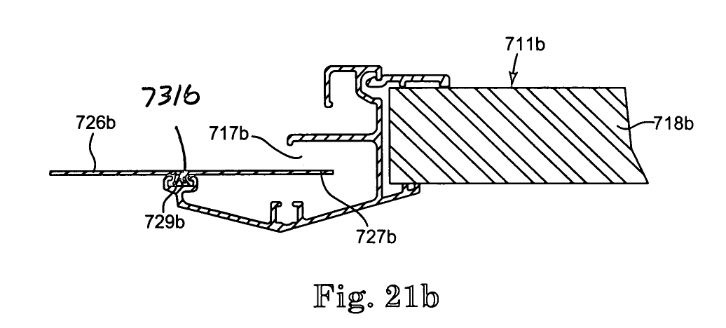

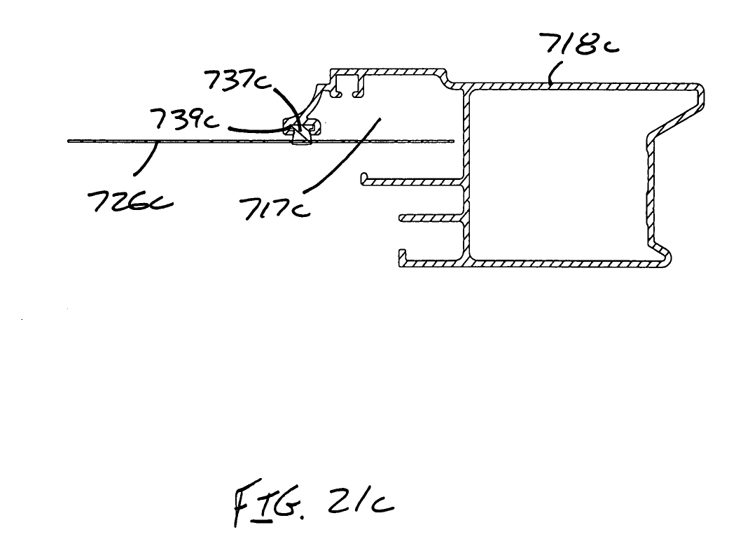

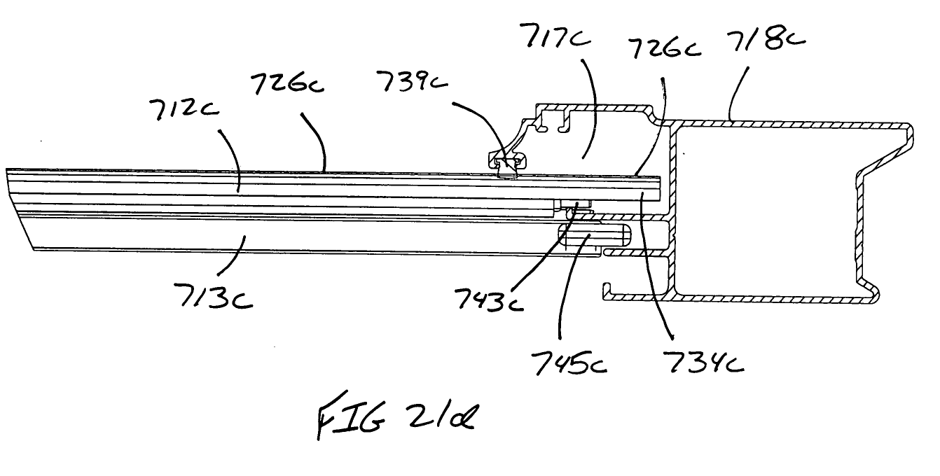

FIG. 16c is a cross-sectional view of the upper sash 712c, pane 714c, and the side frame member 718c of the door 711c taken along the line 16c-16c of FIG. 15c. The upper sash 712c is slidably mounted in a pair of vertical jamb channels 717c of the side frame members 718c. A low friction and/or weather strip material 737c, such as felt or fabric, can be located in channel 739c to reduce wear on the flexible screen 726c and increase the seal between the flexible screen 726c and the side frame members 718c (see FIGS. 21c and 21d).

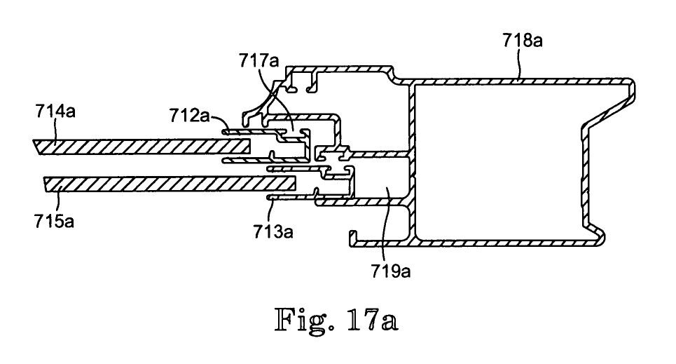

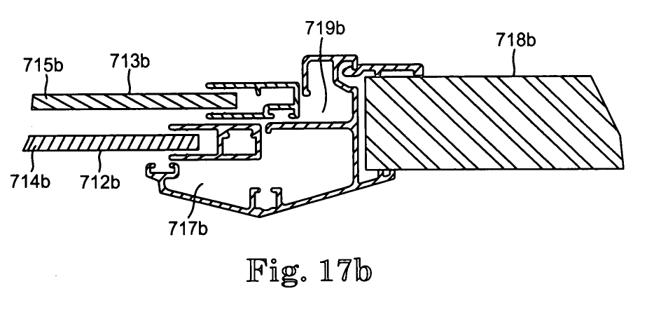

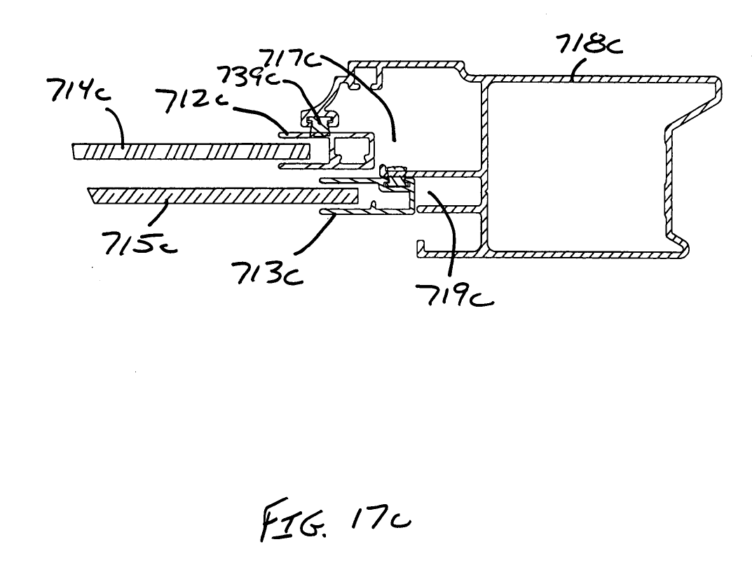

FIG. 17a is a cross-sectional view of the upper sash 712a, the lower sash 713a, and the side frame member 718a of the door 711a taken along the line 17a-17a of FIG. 15a. The upper sash 712a and pane 714a are slidably mounted in the first pair of vertical jamb channels 717a of the side frame members 718a, while the lower sash 713a and pane 715a are mounted in a second pair of vertical jamb channels 719a of the side frame member 718a. Like the first pair of vertical jamb channels 717a as discussed above, the second pair of vertical jamb channels 719a are preferably identical in construction. In one embodiment, the lower sash 713a is slidably mounted in the vertical jamb channels 719a. In another embodiment, the lower sash 713a is fixedly mounted in the vertical jamb channels 719a.

FIG. 17b is a cross-sectional view of the upper sash 712b, the lower sash 713b, and the side frame member 718b of the door 711b taken along the line 17b-17b of FIG. 15b. The upper sash 712b and pane 714b are slidably mounted in the first pair of vertical jamb channels 717b of the side frame members 718b, while the lower sash 713b and pane 715b are mounted in a second pair of vertical jamb channels 719b of the side frame member 718b. The extrusion forming the jamb channels 717b is attached to the solid side frame 718b. The lower sash 713b is preferably slidably mounted in the vertical jamb channels 719b.

FIG. 17c is a cross-sectional view of the upper sash 712c, the lower sash 713c, and the side frame member 718c of the door 711c taken along the line 17c-17c of FIG. 15c. The upper sash 712c and pane 714c are slidably mounted in the first pair of vertical jamb channels 717c of the side frame members 718c, while the lower sash 713c and pane 715c are mounted in a second pair of vertical jamb channels 719c of the side frame member 718c. The lower sash 713c is optionally slidably mounted in the vertical jamb channels 719c. In another embodiment, the lower sash 713c is fixedly mounted in the vertical jamb channels 719c.

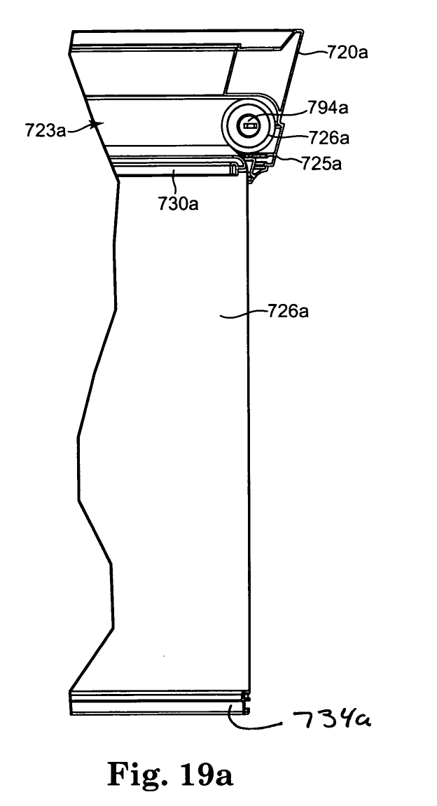

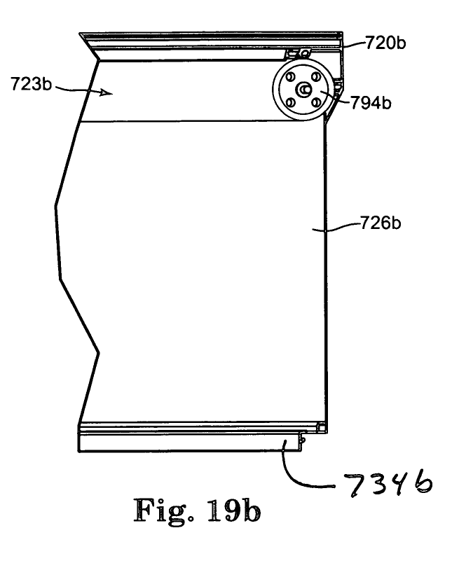

FIGS. 18a and 19a are various view of the housing 722a and the retractable screen assembly 723a. In the illustrated embodiment, portion 725a of the housing 722a is formed from the top rail 720a while portion 727a of the housing 722a is a separate component. The portion 727a is preferably made from the same material (e.g., vinyl or aluminum) as the side frame members 718a.

The retractable screen assembly 723a includes a cylindrically-shaped roller 724a rotatably mounted to a fixed rod 794a. The roller 724a is preferably concentrically aligned with the rod 794a. Both the rod 794a and the roller 724a extend longitudinally between the side frame members 718a of the door 711a.

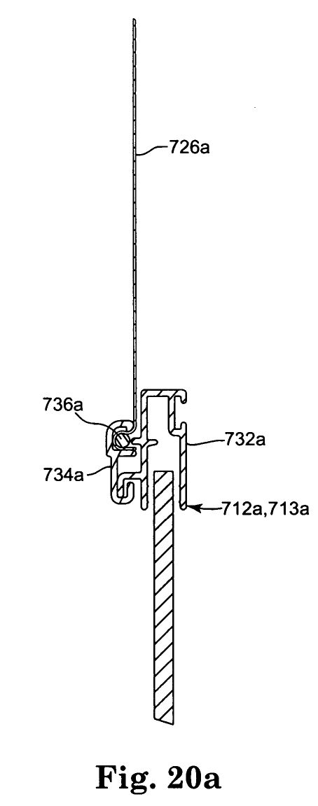

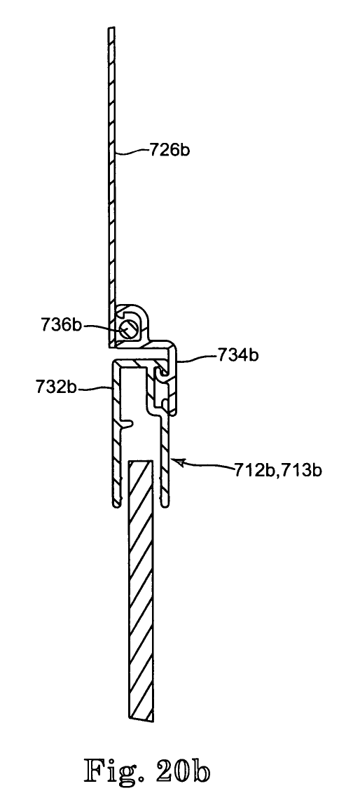

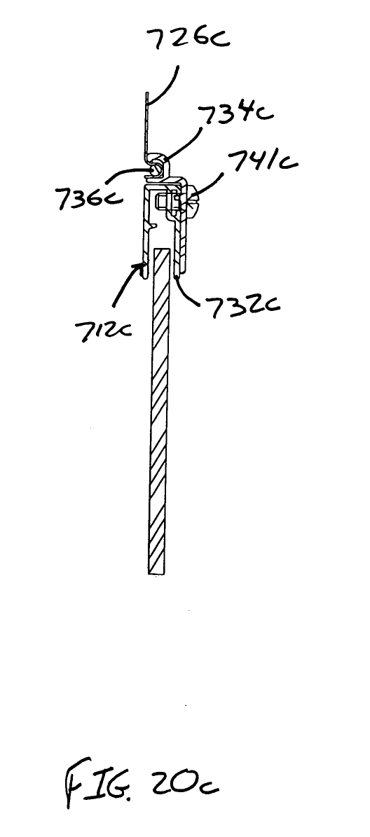

The free end of the flexible screen 726a is attached to attachment member 734a that attaches to one of the sashes 712a, 713a, discussed further in connection with FIG. 20a. Attachment member 734a is preferably the same width as the flexible screen 726a and extends into the channels 719a along with the flexible screen 726a.

The flexible screen 726a is wrapped on the roller 724a and extends through an opening 728a in the housing 722a. Deflection bar 730a is positioned at the opening 728a, providing a deflecting force to stretch the flexible screen 726a tight and positioned in the proper plane. The deflection bar 730a may be of any suitable shape, but preferably has a shape that maintains a suitable level of friction with the screen 726a. The deflection bar 730a serves a number of functions. First, the deflection bar 730a can be constructed from a material that permits the screen 726a to slide smoothly without tearing or wrinkling. Alternatively, the deflection bar 730a can be constructed from a material that provides a desired amount of friction with the screen 726a. The deflection bar 730a also serve to align the screen 726a within the channels 717a of the side frame members 718a as shown in FIG. 20.

FIGS. 18b and 19b are various view of the housing 722b and the retractable screen assembly 723b. In the illustrated embodiment, portions 725b and 727b of the housing 722b are separate components attached to the solid portion of the rail 720b. The portions 725b and 727b is preferably made from the same material (e.g., vinyl or aluminum). The free end of the flexible screen 726b is attached to attachment member 734b that attaches to one of the sashes 712b, 713b, discussed further in connection with FIG. 20b.

The flexible screen 726b is wrapped on the roller 724b and extends through an opening 728b in the housing 722b. Bar 730b positioned at the opening 728a can optionally provide a deflecting force to stretch the flexible screen 726a tight. Alternatively, a low friction material and/or weather strip material, such as felt or fabric, can be located in channel 731b to reduce wear on the screen 726a and increase the seal between the screen 726a and the side frame members 718a.

FIG. 18c is a sectional view of the housing 722c and the retractable screen assembly 723c. In the illustrated embodiment, portion 725c of the housing 722c is formed from the top rail 720c while portion 727c of the housing 722c is a separate component. The portion 727c is preferably made from the same material (e.g., vinyl or aluminum) as the side frame members 718c.

The retractable screen assembly 723c includes a cylindrically-shaped roller 724c rotatably mounted to a fixed rod 794c. The flexible screen 726c is wrapped on the roller 724c and extends through an opening 728c in the housing 722c. Deflection bar 730c is positioned at the opening 728c, providing a deflecting force to stretch the flexible screen 726c tight and to position it in the proper plane. The deflection bar 730c may be of any suitable shape, but preferably has a shape that maintains a suitable level of friction with the screen 726c.

Referring to FIG. 20a, the free end of the flexible screen 726a is attached to a top frame member 732a of the upper sash 712a (or a bottom frame member 732a of the lower sash 713a) through use of an attachment member 734a. The flexible screen 726a is mounted to the attachment member 734a by at least one spline 736a. The flexible screen 726a can be detached from the frame members 732a by removing the spline 736a from the member 734a.

Referring to FIG. 20b, the free end of the screen 726b is attached to top frame member 732b of the upper sash 712b (or the bottom frame member 732b of the lower sash 713b) through use of an attachment member 734b. The flexible screen 726b is mounted to the attachment member 734b by a spline 736b. Although only two exemplary attachment methods are illustrated herein, other methods of attaching the flexible screen 726 to the upper sash 712 can be used.

Referring to FIG. 20c, the free end of the flexible screen 726c is attached to a top frame member 732c of the upper sash 712c through use of an attachment member 734c. The flexible screen 726c is mounted to the attachment member 734c by at least one spline 736c. The attachment member 734c is preferably attached to the top frame member 732c by a mechanical fastener 741c, such as screws, clips, and the like.

FIG. 21a is a cross-sectional view of the flexible screen 726a and the side frame member 718a of the door 711a taken along the line 21a-21a of FIG. 15a. The flexible screen 726a includes two identical peripheral portions retained in each of the vertical jamb channels 719a of the side frame members 718a. Since the two vertical jamb channels 719a are mirror images of each other, FIG. 21a shows only one vertical jamb channel 719a with one peripheral portion 727a of the retractable screen 726a retained therein. A low friction material 731a, such as felt or fabric, can be located in channel 729a to reduce wear on the screen 726a and increase the seal between the screen 726a and the side frame members 718a.

FIG. 21b is a cross-sectional view of the flexible screen 726b and the side frame member 718b of the door 711b taken along the line 21b-21b of FIG. 15b. The flexible screen 726b includes two identical peripheral portions retained in each of the vertical jamb channels 717b of the side frame members 718b. Since the two vertical jamb channels 717b are mirror images of each other, FIG. 21b shows only one vertical jamb channel 717b with one peripheral portion 727b of the retractable screen 726b retained therein. A low friction material 731b, such as felt or fabric, can be located in channel 729b.

FIG. 21c is a cross-sectional view of the flexible screen 726c and the side frame member 718c of the door 711a taken along the line 21c-21c of FIG. 15c. The flexible screen 726c extends into the channel 717c along with a portion of the upper sash 712c. Low friction material 737c, such as felt or fabric, can be located in channel 739c to reduce wear on the screen 726c and increase the seal between the screen 726c and the side frame members 718c.

FIG. 21d is a cut-away view of the side frame member 718c of the door 711c taken along the line 21d-21d of FIG. 15c. The upper sash 712c slidably engages with the channels 717c. The outer surface of the upper sash 712c is positioned to slidably engaged with low friction material 739c located in the side frame member 718c. The inner surface of the upper sash 712c slidably engages with the lower sash 713c. The upper sash 712c includes member 743c, preferably located near the top frame member 732c that extends into the channels 717c. The member 743c prevents the upper sash 712c from tipping inward off of the channels 717c. Similarly, the lower sash 713c includes member 745c that extends into the channel 719c to retain the lower sash 713c in the side frame members 718c.

The flexible screen 726c and a portion of the attachment member 734c extend into the channel 717c. The attachment member 734c serves to retain distal edges of the flexible screen 726c in the channel 717c and to reduce the risk of wrinkles in the flexible screen 726c. If the screen material is pulled from the channels 717c during operation, the user merely raises the sash 712c and then lowers the sash 712c to the desired location. The attachment member 734c will reinsert the edges of the flexible screen 726c into the channels 717c.

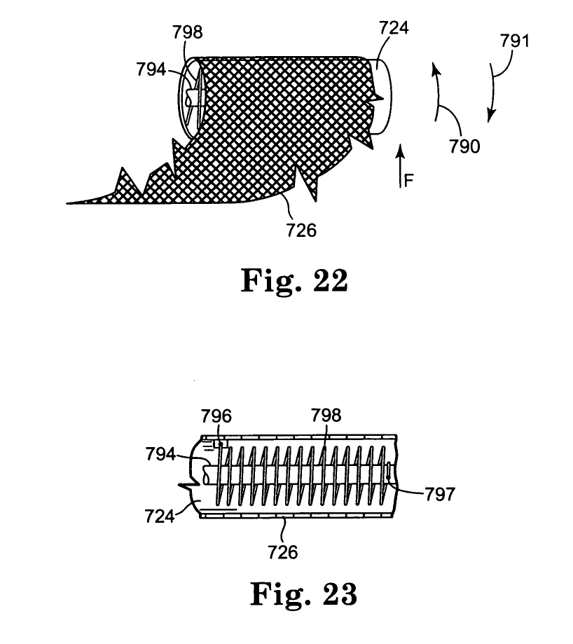

FIGS. 22 and 23 illustrate various aspects of the retractable screen mechanisms 723a, 723b, and 723c (referred to collectively by the reference numerals without the alpha designation). The roller 724 is connected to a rod 794 by a spring member 797. A first end of flexible screen 726 is attach to the roller 724 and the screen 726 is wrapped on the roller 724. Several windings of the screen 726 may be necessary, depending on the diameter of the roller 724 and the size of the opening to be covered. The roller 724 can be made of vinyl, aluminum, or other suitable material that serves to support the screen 726 wrapped thereon.

When the upper sash 712 is in a closed position, most of the flexible screen 726 is stored on the roller 724. As the upper sash 712 is lowered, the screen 726 is dispensed or unrolled from the roller 724, causing the roller 724 to rotate in a direction as indicated by the arrow 791. The spring member 798 inside the roller 724 then winds or tightens around the rod 794. While the illustrated embodiment is of a torsional spring, a variety of other biasing members can be used, such as for example an a coil spring or elastic band. A suitable spring is available from Faber A/S, Denmark under the product designation model no. 2475241 and model no. 2475222.

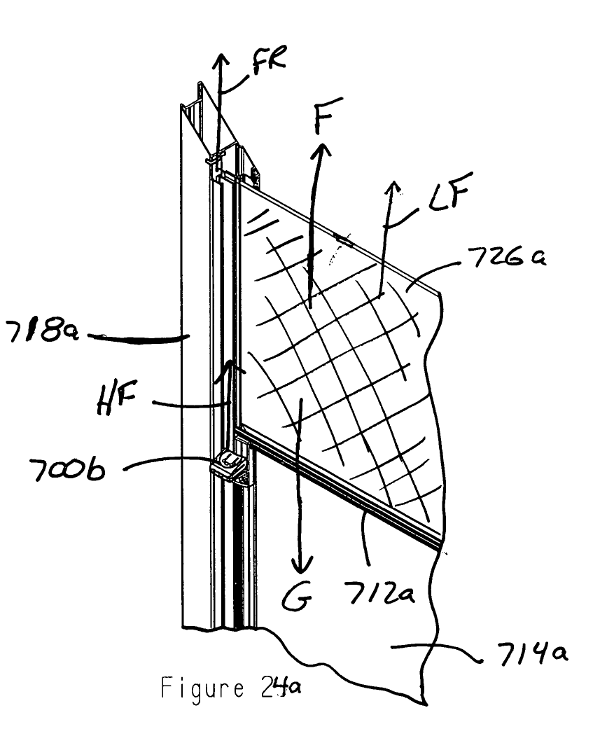

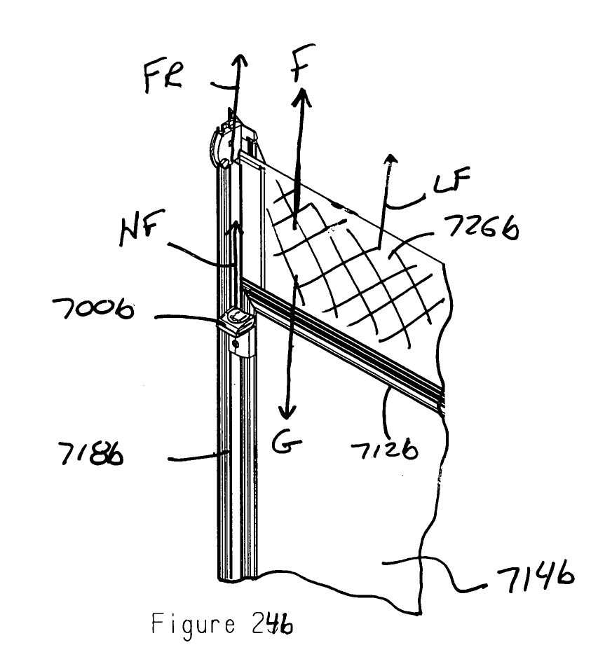

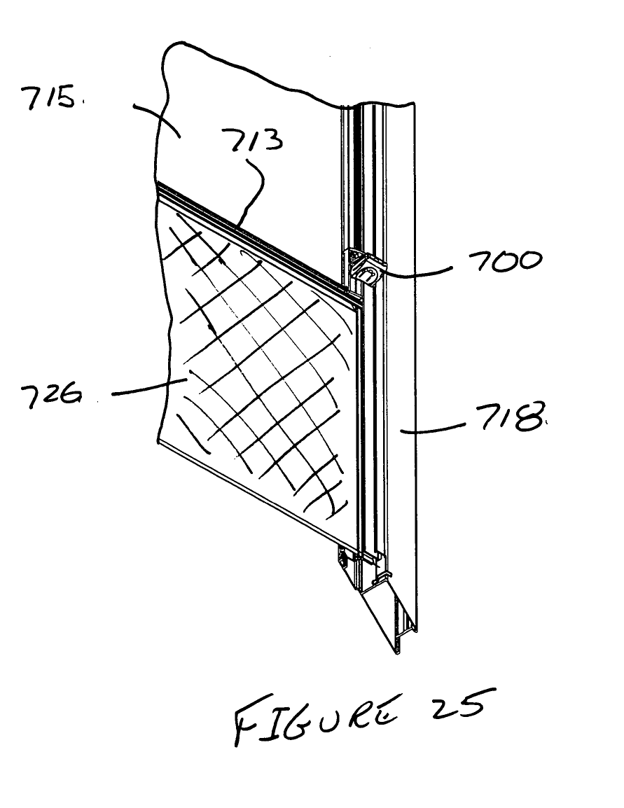

In the illustrated embodiment, one end 796 of the spring member 798 is attached to the inside of the roller 724, while the other end 797 of the spring member 798 is connected to the rod 794. As the spring member 798 winds or tightens around the rod 794, the spring member 798 applies a torque 790 to the roller 724 that attempts to rewind the screen 726 onto the roller 724. The torque 790 applies a lifting force LF through the flexible screen 726 to the moveable sash 712. As will be discussed below, the lifting force LF can constitute the entire positioning force F, or some portion thereof. Operation of the various embodiment is illustrated in FIGS. 24a and 24b. Positioning force F is preferably sufficient to counteract the force of gravity G on the upper sashes 712a, 712b, 712c (referred to collectively by the reference numeral without the alpha designation). That is, the positioning force F is preferably generally the same magnitude, but opposite in direction to gravity “G” acting on the sash 712. The positioning force F is preferably sufficient to retain the sash 712 in a infinite number of desired locations. In practical terms, a user simply positions the moveable sash to a desired location and it stays there without any further actions by the operator.

In the preferred embodiment, the positioning force F is generated entirely by the retractable screen assembly 723. In this embodiment the positioning force F equals the lifting force LF. In another embodiment, the positioning force F is a combination of the lifting force LF and the friction force FR between the sash 712 and the side frame members 718. As used herein, “positioning force” refers to a force, either alone or in combination with friction between a sash and the jambs, sufficient to retain a movable sash in a particular location until acted on by an external force other than gravity. In the preferred embodiment, the positioning force accomplishes this task without the use of other mechanisms, such as latches, counterbalances, springs, and the like.

In the embodiment where the friction force FR contributes a portion of the positioning force F, the positioning force F equals the friction force FR plus the lifting force LF. The ratio of the friction forces FR and positioning force F can be engineered depending on the application. For example, the frictional force FR can be about 0.1 G and the lifting force about 0.9 G. In some embodiments, friction can be about 0.2 G to about 0.4 G and the lifting force about 0.8 G to about 0.6 G, respectively. The frictional force FR, however, is preferably minimized since friction typically acts in both directions requiring the operator to overcome gravity G and friction force FR in order to raise the sash 712.

The operation of alternate embodiments that includes sash positioning device 700 are also illustrated in FIGS. 24a and 24b. Conventional sash positioning devices, such as latches can be used with this embodiment. The sash positioning device 700 generates a holding force HF between the moveable sash 712 and the side frame members 718. An operator disengages the sash positioning device 700 as discussed above in connection with FIG. 3. When the upper sash 712 is located in the desired position, the sash positioning device 700 is moved from the disengaged position to the engaged position. The retractable screen 726 automatically fills the opening 727 formed in the side frame members 718 and the top rail 720 of the door 711 as shown in FIGS. 15a, 15b and 15c.

In one embodiment, the holding force HF is greater than, or equal to, the force G, and hence is sufficient to retain the sash 712 in the desired location. In another embodiment, the holding force HF is less than the force G. In this embodiment, the positioning force F cooperates with the holding force HF to retain the sash 712 in the desired location. In either embodiment, the positioning force F (lifting force LF and/or friction force FR) assists the operator in raising the upper sash 712 and acts as a brake on downward travel of the upper sash 712. The positioning force F can be greater than, less than, or equal to the force of gravity G acting on the upper sash 712. The force F is preferably at least about 0.2 G, and more preferably about 0.4 G and most preferably about 0.6 G to about 0.8 G.

As illustrated in FIG. 25, the operation of the lower sash 713 is substantially the same as discuss above in connection with the upper sash 712 except that the retractable screen assembly does not provide a lifting force F. As the sash 713 is moved upward to an open position, the retractable screen 726 is dispensed or unrolled from the rollers 724. The spring member 798 provides a torque 790 to the roller 724 that resist unrolling of the screen 726. The torque 790 provided by the spring member 798 generates the force F that opposes raising of the lower sash 713 and keeps the flexible screen 726 under tension. Ideally, the positioning force F is kept as small as possible to effectively retract the screen 726 as the sash 713 is lowered to the closed position. In one embodiment, a supplemental lifting force is applied to the lower sashes 713, such as disclosed in commonly assigned U.S. patent application No. 2002/0121618 (application Ser. No. 10/026,669).

All patents and patent applications disclosed herein, including those disclosed in the background of the invention, are hereby incorporated by reference. Although the present invention has been described with reference to preferred embodiments, workers skilled in the art will recognize that changes may be made in form and detail without departing from the spirit and scope of the invention. In addition, the invention is not to be taken as limited to all of the details thereof as modifications and variations thereof may be made without departing from the spirit or scope of the invention. For example, although the retractable screen is described herein in connection with an exemplary door, it can be used with other fenestration products having a movable sash with one or more sash positioning devices.

1. A door comprising:
vertical jambs comprising vertical channels;
a window sash movable in the vertical channels;
a retractable screen assembly attached to the door, the retractable screen assembly comprising;
a roller;
a flexible screen attached at a first end to the roller and at a second end to the movable window sash; and
a biasing mechanism adapted to apply a continuous torque to the roller, the torque generating a positioning force on the window sash equal to at least 50% of the force of gravity acting on a window sash, such that the window sash can be positioned at an infinite number of locations along the vertical channels.

2. The door of claim 1 wherein the positioning force comprises at least 80% of the force of gravity acting on the window sash.

3. The door of claim 1 wherein the positioning force substantially counterbalances the force of gravity acting on the window sash.

4. The door of claim 1 wherein the positioning force applies a braking force on the window sash as it moves in a downward direction.

5. The door of claim 1 wherein the positioning force comprises a friction force acting between the window sash and the vertical channels.

6. The door of claim 5 wherein the friction force combines with the torque to retain the window sash in an infinite number of locations along the vertical channels.

7. The door of claim 5 wherein the friction force comprises about 5% to about 20% of the force of gravity acting on the window sash.

8. The door of claim 1 wherein the flexible screen is retracted when the window sash is moved from an open position to a closed position.

9. The door of claim 1 wherein the flexible screen is drawn across an opening formed when the window sash is in an open position.

10. The door of claim 1 wherein edges of the flexible screen are releasably retained in the vertical channel when the window sash is in an open position.

11. The door of claim 1 wherein the door comprises one of a hollow core storm door and a solid core storm door.

12. The door of claim 1 wherein the window sash comprises the upper window sash of a door.

13. The door of claim 1 wherein the flexible screen is attached to a frame member on the window sash.

14. The door of claim 1 wherein the flexible screen comprises one of a blind, a translucent film, a reflective film, or a bug screen.

15. The door of claim 1 wherein the biasing mechanism comprises a spring.

16. The door of claim 1 comprising a sash positioning device attached to the window sash and releasably engagable with at least one contact surface on the vertical channel, such that the sash positioning device can engage the vertical channel at an infinite number of locations.

17. The door of claim 16 wherein the sash positioning device and the positioning force cooperate to retain the window sash at an infinite number of location within the vertical channel.

18. The door of claim 1 comprising a sash positioning device attached to the vertical jambs and releasably engagable with at least one contact surface on the window sash, such that the sash positioning device can engage the window sash at an infinite number of locations.

19. The door of claim 18 wherein the sash positioning device and the positioning force cooperate to retain the window sash at an infinite number of location within the vertical channel.

20. A door comprising:
vertical jambs comprising vertical channels;
a window sash movable in the vertical channels;
a sash positioning device adapted to retain the window sash at any of an infinite number of locations along the vertical channels;
a retractable screen assembly attached to the door, the retractable screen assembly comprising;
a roller;
a flexible screen attached at a first end to the roller and at a second end to an upper edge of the movable window sash; and
a retraction mechanism continuously acting on the roller, the retraction mechanism generating a continuous positioning force on the window sash having a magnitude of at least 20% of the force of gravity acting on a window sash, such that the window sash can be positioned at an infinite number of locations along the vertical channels.

21. The door of claim 20 wherein the positioning force has a magnitude of about 40% of the force of gravity acting on the window sash.

22. The door of claim 20 wherein the positioning force has a magnitude of about 60% of the force of gravity acting on the window sash.

23. The door of claim 20 wherein the positioning force has a magnitude of about 80% of the force of gravity acting on the window sash.

24. A door comprising:
vertical jambs comprising vertical channels;
a window sash movable in the vertical channels;
a sash positioning device attached to the window sash and releasably engagable with at least one contact surface on the vertical channel, such that the sash positioning device can engage the vertical channel at an infinite number of locations; and
a retractable screen assembly attached to the door, the retractable screen assembly comprising a roller and a flexible screen attached at a first end to the roller and at a second end to an upper edge of the movable window sash, and a retraction mechanism adapted to provide a continuous positioning force on the window sash.

25. The door of claim 24 wherein the window sash comprises the upper window sash of the door.

26. The door of claim 24 wherein the window sash comprises the lower window sash of the door.

27. The door of claim 24 wherein the retractable screen assembly is attached to a top of the door.

28. The door of claim 24 wherein the retractable screen assembly is attached to a bottom of the door.

29. The door of claim 24 wherein the positioning force comprises at least 20% of the force of gravity acting on the window sash.

30. The door of claim 24 wherein the positioning force comprises at least 40% of the force of gravity acting on the window sash.

31. The door of claim 24 wherein the positioning force substantially counterbalances the force of gravity acting on the window sash.

32. A method of operating a movable sash in a door comprising the steps of:
slidably engaging a window sash with vertical channels on vertical jambs;
attaching a first end of a flexible screen to a roller and a second end to an edge of the window sash;
applying a torque to the roller; and
continuously applying a positioning force to the window sash, the positioning force equal to at least 50% of the force of gravity acting on a window sash, such that the window sash can be positioned at an infinite number of locations along the vertical channels.

33. The method of claim 32 wherein applying the positioning force comprises generating a friction force between the window sash and the vertical channels, the friction force equal to about 5% to about 20% of the force of gravity acting on the window sash.

34. The method of claim 32 comprising retracting the flexible screen when the window sash is moved from an open position to a closed position.

35. The method of claim 32 comprising drawing the flexible screen across an opening formed when the window sash is in an open position.

36. The method of claim 32 comprising retaining a portion of the flexible screen in the vertical channel when the window sash is in an open position.

37. The method of claim 32 wherein the positioning force is equal to about 80% of the force of gravity acting on the window sash.

38. The method of claim 37 wherein the positioning force substantially counterbalances the force of gravity acting on the window sash.

39. The method of claim 37 wherein the positioning force applies a braking force on the window sash as it moves in a downward direction.

40. The method of claim 32 comprising
attaching a sash positioning device to the window sash; and
releasably engaging the sash positioning device with at least one contact surface on the vertical channel, such that the sash positioning device can engage the vertical channel at an infinite number of locations.

41. The method of claim 32 comprising
attaching a sash positioning device to the vertical jambs; and
releasably engaging the sash positioning device with at least one contact surface on the window sash, such that the sash positioning device can engage the window sash at an infinite number of locations.

42. A method of operating a movable sash in a door comprising the steps of:
slidably engaging a window sash with vertical channels on vertical jambs;
releasably engaging the sash positioning device with at least one contact surface on the vertical channel, such that the sash positioning device can engage the vertical channel at an infinite number of locations;
attaching a first end of a flexible screen to a roller and a second end to an edge of the window sash; and
continuously applying a torque to the roller, the torque generating a positioning force having a magnitude of at least 20% of the force of gravity acting on a window sash, such that the window sash can be positioned at an infinite number of locations along the vertical channels

43. The method of claim 42 wherein the positioning force has a magnitude of about 40% of the force of gravity acting on the window sash.

44. The method of claim 42 wherein the positioning force has a magnitude of about 60% of the force of gravity acting on the window sash.

45. The method of claim 42 wherein the positioning force has a magnitude of about 80% of the force of gravity acting on the window sash.

46. A method of operating a movable sash in a door comprising the steps of:
moving an engaging member on a sash positioning device to a disengaged position;
moving a window sash to one of an infinite number of positions along a vertical channel;
positioning a flexible screen attached to the window sash across an opening formed by movement of the window sash;
applying a continuous positioning force to the flexible screen, the positioning equal to at least 20% of the force of gravity acting on the window sash; and
engaging the engaging member on the sash positioning device with a portion of the vertical channel to secure the window sash in one the infinite number of positions along the vertical channel.
